(19) United States
(12) Patent Application Publication
(10) Pub. No.: US 2021/0271380 A1
(43) Pub. Date: Sep. 2, 2021

(54) DISPLAY DEVICE

(71) Applicant: SHARP KABUSHIKI KAISHA, Sakai City (JP)

(72) Inventor: KIHO SAKAMOTO, Sakai City (JP)

(21) Appl. No.: 17/168,658

(22) Filed: Feb. 5, 2021

(30) Foreign Application Priority Data
Feb. 28, 2020 (JP) 2020-033486
Feb. 28, 2020 (JP) 2020-033487

(51) Int. Cl. G06F 3/0484; G06F 3/041; G06F 3/0482; G06F 3/0481

(52) U.S. Cl. CPC G06F 3/04845; G06F 3/04812; G06F 3/0482; G06F 3/041

(57) ABSTRACT

A display device according to the present disclosure includes a display that presents content; an inputter; and a controller, wherein the controller receives input of a handwritten figure for the presented content via the inputter and outputs, as comment information, an image where the handwritten figure and an image of content in a range including the handwritten figure are superimposed.

### CROSS-REFERENCE TO RELATED APPLICATION

The present application claims priority from Japanese Patent Application Numbers 2020-33486 and 2020-33487, the content of which is hereby incorporated by reference into this application.

### BACKGROUND OF THE INVENTION

### Field of the Invention

The present invention relates to a display device.

### Description of the Background Art

In recent years, touch or pen-input compatible personal computers and tablets have become widespread, and various techniques regarding handwriting input have been disclosed.

There is a disclosed technique in which, when a plurality of strokes is received in an input region, there is a response to receiving the plurality of handwritten strokes. For example, when multiple handwriting strokes are text inputs, one or more handwriting word blocks are generated and are positioned in accordance with a first predetermined layout criterion, and when multiple handwriting strokes are sketches, a sketch content object is generated and is positioned in accordance with a second predetermined layout criterion different from the first predetermined layout criterion (see Japanese Translation of PCT International Patent Application No. 2018-530042).

Furthermore, there is a disclosed technique in which a predetermined command (gesture) is input to the previously input image data so as to delete the image data (see Japanese Unexamined Patent Application Publication No. Hei. 6-309093).

A review by another person is necessary to brush up content such as a document file, and the use of for example applications that allow the input of a comment have been also promoted. Some of the applications have the function to present a list of comments added to content. Unfortunately, there has been an issue such that it is difficult to accurately indicate the point or area of interest simply by the presentation of a list of comments, and therefore the user has difficulty in determining for which part of the content a handwritten comment has been input.

According to the techniques disclosed in Japanese National Publication of International Patent Application No. 2018-530042 and Japanese Patent Application Publication No. 6-309093, even if the user desires to add a comment to a predetermined area in the content, it is difficult for the user to determine the area of the content to which the comment is to be added with a simple technique.

In order to solve the above-described issue, the present disclosure may have an object to provide a display device that outputs, as comment information, the image where a handwritten figure and the image of content including the handwritten figure are superimposed.

Furthermore, the present disclosure may have an object to provide a display device that specifies an area and stores the content in the area as a comment.

### SUMMARY OF THE INVENTION

A first embodiment for solving the above-described issue is a display device including a display (e.g., a display 110 in FIG. 2) that presents content; an inputter (e.g., an inputter 120 in FIG. 2); and a controller (e.g., a controller 100 in FIG. 2), wherein the controller receives input of a handwritten figure for the presented content via the inputter and outputs, as comment information, an image where the handwritten figure and an image of content in a range including the handwritten figure are superimposed.

A second embodiment is a display device including a display (e.g., the display 110 in FIG. 2) that presents content; an inputter (e.g., the inputter 120 in FIG. 2); and a controller (e.g., the controller 100 in FIG. 2), wherein the controller receives input of a handwritten figure for the presented content via the inputter and, when the handwritten figure of the received input is an arrow, outputs, as comment information, an image where an image of content in a range included in an area indicated by the arrow and the handwritten figure included in the range included in the area indicated by the arrow are superimposed.

A third embodiment is a display device including a display (e.g., the display 110 in FIG. 2) that presents content; an inputter (e.g., the inputter 120 in FIG. 2); a storage (e.g., a storage 150 in FIG. 2); and a controller (e.g., the controller 100 in FIG. 2), wherein the storage is capable of storing, as a comment, a character or an image in association with the content, and the controller specifies an area input via the inputter from content presented on the display and causes a first image based on content in the specified area to be stored as a comment.

A fourth embodiment is a display device including a display (e.g., the display 110 in FIG. 2) that presents content; an inputter (e.g., the inputter 120 in FIG. 2); a storage (e.g., the storage 150 in FIG. 2); and a controller (e.g., the controller 100 in FIG. 2), wherein the storage is capable of storing, as a comment, a character or an image in association with the content, and the controller causes the display to present an input area for inputting a first image on the content in a superimposed manner, specifies an area including a range where the input area is superimposed, and causes the first image input to the input area and a second image based on content in the specified area to be stored as a comment.

With the display device according to the present disclosure, it may be possible to output, as comment information, the image where a handwritten figure and the image of content including the handwritten figure are superimposed.

Further, with the display device according to the present disclosure, it may be possible to specify an area and store content in the area as a comment.

### BRIEF DESCRIPTION OF THE DRAWINGS

FIGS. 1A to 1C are diagrams illustrating an outline of a system according to a first embodiment and a fourth embodiment;

FIG. 2 is a diagram illustrating a functional configuration of a display device according to the first embodiment and the fourth embodiment;

FIGS. 3A and 3B are tables illustrating content information and comment information according to the first embodiment;

FIG. 4 is a chart illustrating an operation according to the first embodiment;

FIGS. 5A to 5C are diagrams illustrating an operation example according to the first embodiment;

FIGS. 6A and 6B are diagrams illustrating an operation example according to the first embodiment;

FIG. 7 is a chart illustrating an operation according to a second embodiment;

FIGS. 8A to 8D are diagrams illustrating an operation example according to the second embodiment;

FIG. 9 is a diagram illustrating an operation example according to a third embodiment;

FIGS. 10A and 10B are diagrams illustrating an operation according to the third embodiment;

FIGS. 11A to 11C are tables illustrating content information, handwritten figure information, and comment information according to the fourth embodiment;

FIG. 12 is a chart illustrating a comment storage process according to the fourth embodiment;

FIGS. 13A to 13C are diagrams illustrating an operation example according to the fourth embodiment;

FIGS. 14A to 14C are diagrams illustrating an operation example according to the fourth embodiment;

FIG. 15 is a chart illustrating a comment storage/addition process according to a fifth embodiment;

FIGS. 16A to 16C are diagrams illustrating an operation example according to the fifth embodiment;

FIG. 17 is a chart illustrating a comment storage process according to a sixth fourth embodiment;

FIGS. 18A to 18C are diagrams illustrating an operation example according to the sixth embodiment;

FIG. 19 is a chart illustrating a comment storage process according to a seventh embodiment;

FIG. 20 is a chart illustrating a file attachment process according to an eighth embodiment;

FIGS. 21A to 21D are diagrams illustrating an operation example according to the eighth embodiment;

FIG. 22 is a chart illustrating a display switching process according to a ninth embodiment; and

FIGS. 23A and 23B are diagrams illustrating an operation example according to the ninth embodiment.

### DESCRIPTION OF THE PREFERRED EMBODIMENTS

Embodiments in a case where a display device according to the present invention is applied are described below. The embodiments are described for convenience of description of the present invention, and the technical scope of the present invention is not limited to the embodiments below.

### 1. First Embodiment

### 1.1 Overall Configuration

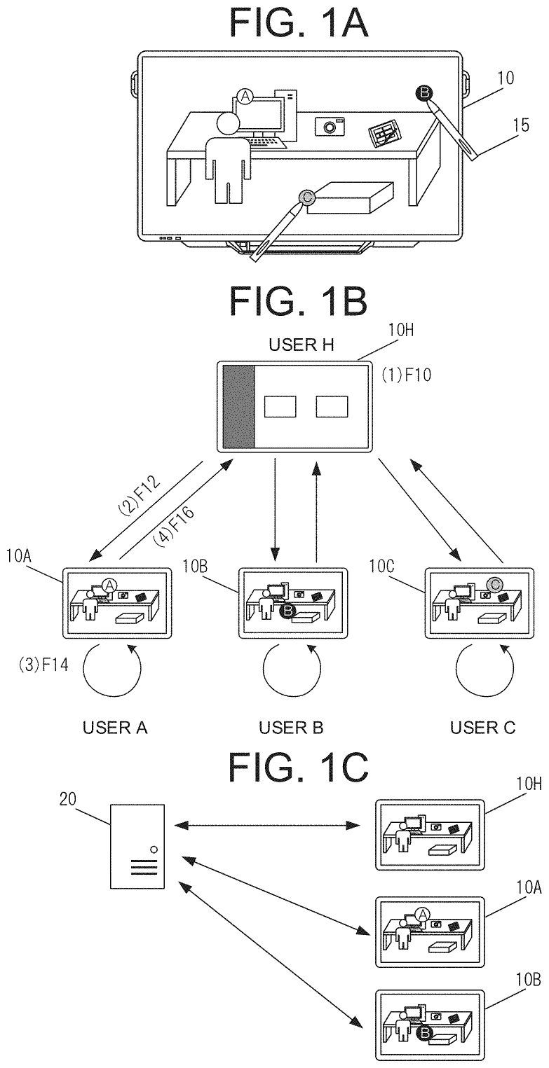

FIG. 1A is a diagram illustrating the external appearance of a display device 10. The display device 10 may be, for example, an information processing device, such as a tablet terminal device or a laptop computer, a large-sized display device such as a display device used in an electronic whiteboard or an electronic blackboard (interactive whiteboard (IWB)), or a table display device. A user's operation on the display device 10 is input, for example, when a touch on a touch panel is detected or an operation using an input device 15 is detected.

Although the display device 10 is described as a single device according to the present embodiment, it is possible to have the configuration including a plurality of display devices or the configuration in which a display device and a server work in cooperation with each other.

For example, as illustrated in FIG. 1B, it is possible to use the configuration of a system including a display device 10H used by a user H who is an administrator and a plurality of display devices used by other users. The outline of an operation of the entire system is described below.

(1) With the display device 10H used by the user H who is an administrator, the user H selects content (F10). The user H may add a comment to the content by himself/herself. The comment may be stored as a file (data) separately from the content.

(2) With a display device 10A used by a user A, the user A reads the content and the comment as appropriate from the display device 10H (F12).

(3) The user A performs the process to add a comment to the read content (F14).

(4) The comment added to the content by the user A is transmitted to the display device 10H (F16). The display device 10H updates the comment corresponding to the content based on the received comment so that the comment added by the user A is applied to the content.

(5) In the same manner, a user B and a user C also perform the process to add a comment to the content selected by the user H.

Thus, the use of this system allows each user to add a comment to the content.

The display device may be a system that is connectable to a server device. For example, as illustrated in FIG. 1C, a server device 20 capable of communicating with the display device 10 is connected to the system. The server device 20 may be in the same network or in the cloud. As illustrated in FIG. 1C, each of the display devices 10 is configured to be able to communicate with the server device 20. Specifically, the content stored in the display device 10H and the data regarding the comment in the configuration of FIG. 1B are stored in the server device 20. The display device 10H, the display device 10A, and a display device 10B refer to the server device 20 so as to perform the same operation as the operation in the above-described configuration.

Although a single display device works in the case described below, what is called a person skilled in the art may also apply it to a second configuration and a third configuration.

### 1.2 Functional Configuration

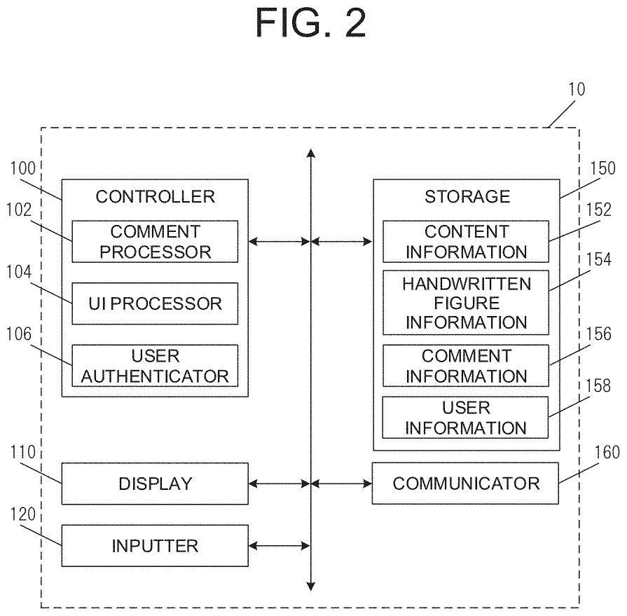

Next, a functional configuration of the display device 10 is described with reference to FIG. 2. Each configuration is appropriate as long as the configuration includes what is necessary for operation and is not an essential configuration.

The controller 100 is a functional unit that performs the overall control on the display device 10. The controller 100 reads and executes various programs stored in the storage 150 to perform various functions and includes, for example, one or more arithmetic devices (e.g., central processing units (CPUs)).

The controller 100 executes a program to operate as a comment processor 102, a user interface (UI) processor 104, and a user authenticator 106.

The comment processor 102 executes editing processing such as inputting, changing, or deleting of a comment in accordance with an operation input by the user. The comment processor 102 adds necessary information to the comment input by the user and stores the comment in comment information 156 of the storage 150. When the other display device 10 or the server device 20 stores comment information, the comment processor 102 may transmit and receive a comment to and from the other device via a communicator 160.

The comment processor 102 processes the object input by the user as a comment. Examples of objects input by the user include figures, text (characters), and symbols.

For example, the comment processor 102 receives the input of text as a comment when the user makes the input via a software keyboard or a hardware keyboard. The comment processor 102 receives the input figure as a comment when the figure is drawn on the touch panel or the figure is drawn with an operating pen. In the following description, the figure input by a touch operation on the touch panel or an operation with the operating pen is referred to as a handwritten figure. Examples of the handwritten figure include the figure forming a character or a symbol and a figure such as point, line, arrow, or rectangle. The comment processor 102 may receive an input while switching between a text comment and a figure comment in accordance with a touch button or an operation.

The comment processor 102 may recognize a handwritten figure as a character to convert the handwritten figure into text or may generate text as an image. According to the present embodiment, the user may add a comment without being aware of a text input and a handwritten input.

The comment processor 102 may process an image such as a stamp as a comment added by the user.

The comment processor 102 may perform other general editing processes such as operations for insertion, deletion, modification, replacement, and movement, and known editing processes such as change in a character type, movement of a cursor, change in a font, change in the color/thickness of a line, and modification of a line.

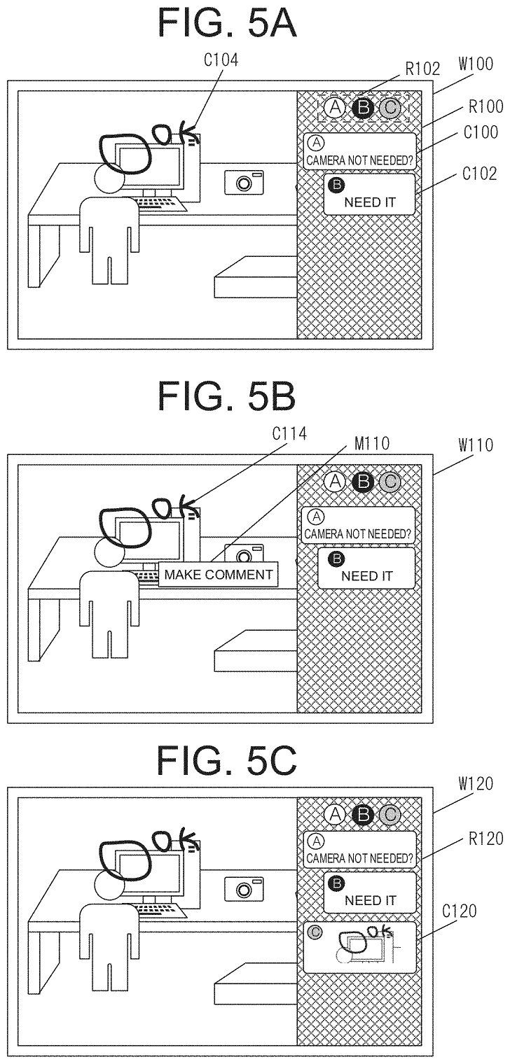

The UI processor 104 generates a user interface screen and presents the user interface screen on the display 110. According to the present embodiment, the UI processor 104 performs the process to display a comment and a list of comments on the display 110. For example, as illustrated in FIG. 5A, the content is displayed on an entire display screen W100, and comments are vertically arranged and displayed on an area R100. Comments may be arranged in chronological order or may be displayed on a per user basis. For example, user icons are displayed on an area R102 of FIG. 5A. When the user selects a user icon, the UI processor 104 reads the comment corresponding to the selected user from the comment information 156 and presents the comment. The UI processor 104 may present a list of comments so as to be superimposed on the content or may divide the display area of the display 110 and display the list of comments in an area different from the area where the content is displayed. The UI processor 104 may selectively display or hide a list of comments.

The user authenticator 106 authenticates a user. Specifically, the user authenticator 106 refers to user information 158 to, for example, authenticate the user who adds a comment or authenticate the owner (user) of the content. The user authenticator 106 may use an external authentication server. When the authentication server is used, the user authenticator 106 and the user information 158 may be stored in the authentication server.

The display 110 presents content and comments and presents various statuses of the display device 10 and the status of an operation input. The display 110 includes, for example, a liquid crystal display (LCD), an organic EL panel, or electronic paper using an electrophoresis system.

The inputter 120 receives an operation input from the user. The inputter 120 includes, for example, a capacitive or pressure-sensitive touch panel. The inputter 120 may include the combination of a touch panel and an operating pen or may be an input device such as a keyboard and a mouse. Furthermore, the inputter 120 may be appropriate as long as the user is able to input information, such as voice input in combination with a microphone, or the like.

The inputter 120 detects the position of the input operation performed by the user and outputs the position as an input position to the controller 100. The input position is preferably, for example, the coordinates on the display screen presented on the display 110 as the position detected on the touch panel. The input position may be the position of a cursor (the position of a row or a column in a sentence) or the position of the provided layout information (for example, above a button or above a scroll bar).

The storage 150 is a functional unit that stores various programs and various types of data needed for an operation of the display device 10. The storage 150 includes, for example, a solid state drive (SSD), which is a semiconductor memory, or a hard disk drive (HDD). The storage 150 stores content information 152, handwritten figure information 154, the comment information 156, and the user information 158.

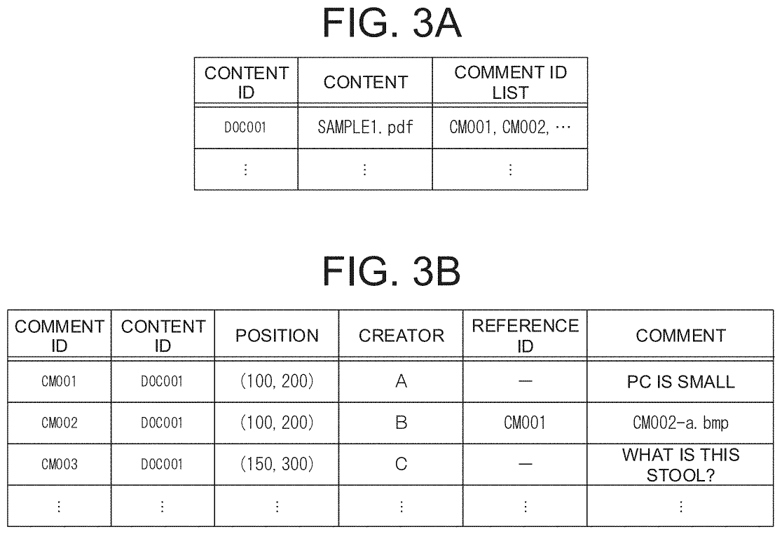

As the content information 152, content and the information about the content are stored. For example, as illustrated in FIG. 3A, the content information 152 includes the following information.
Content ID: the information for identifying content.
Content: the information about content. Examples of the content include a text file, an image file, a Portable Document Format (PDF) file, and an Office file. As these contents, the actual data may be stored, or the storage location (for example, the location of a folder, a uniform resource locator (URL)) may be stored. The content may include one or more pages.
Comment ID list: a list of comment IDs. The comment ID corresponding to the comment added to the content is included.

As the handwritten figure information 154, the information about the handwritten figure input for the content is stored. The handwritten figure input for the content refers to a handwritten figure directly input for the content by being input by handwriting by the user with a finger, an operating pen, or the like, in the range where the content is displayed. As the handwritten figure information 154, a handwritten figure and the content ID of the content for which the handwritten figure is input are stored. The position of the handwritten figure on the content may be stored. The handwritten figure may be stored as a raster image or may be stored as a vector image.

As the comment information 156, a comment added to content by the user and the information about the content are stored. For example, as illustrated in FIG. 3B, the comment information 156 includes the following information.
Comment ID: the information for identifying a comment.
Content ID: the information for identifying the content corresponding to the comment.
Position: the information on the position where the comment is added in the content. The position is a position in the content or in a page of the content and, for example, is indicated as coordinates (XY coordinates). When the content is sentence data such as text data, the position may be represented by using a row and a column.
Creator: the information about the creator of the comment.
Reference ID: the information for identifying the comment (parent comment) referred to by the comment. When the user adds comments hierarchically, the parent comment ID is stored so as to identify the parent comment. Related comments that are parent and child comments are expressed as a comment group.
Comment: the information indicating the details of the comment actually input (added) by the user. For example, text data, image data, data regarding an attached file, and the like, are stored as the details.

As user information 158, the information about a user is stored. As the information for identifying the user, for example, the login ID of each user, the password, the name, the terminal used, the biometric information on the user, and the ID of the pen used for input may be stored. The user information 158 is stored in association with the icon of each user.

The communicator 160 communicates with other devices. For example, the communicator 160 connects to a local area network (LAN) to transmit and receive the information about a comment or transmit and receive a document to and from other devices. As a communication method, communications such as LTE/4G/5G may be used as well as a general LAN for Ethernet (registered trademark).

For each of the above-described configurations, the display device 10 may have a function as appropriate. For example, when each set of data is stored in the display device 10 used by a user (general user) who is not an administrator or the server device 20, the content information 152 and the comment information 156 do not need to be stored in the storage 150. Various types of information may be stored in a server on the cloud as appropriate.

The configuration illustrated in FIG. 2 is appropriate as long as the configuration includes at least the controller 100 and the storage 150 and has any configuration that enables the operation according to the present embodiment. Some functions may be performed by an external device.

For example, the display 110 may be configured as an external device such as a monitor. That is, the display device 10 may include a display device and a terminal device, and the terminal device may include the controller 100 and the storage 150.

### 1.3 Process Flow

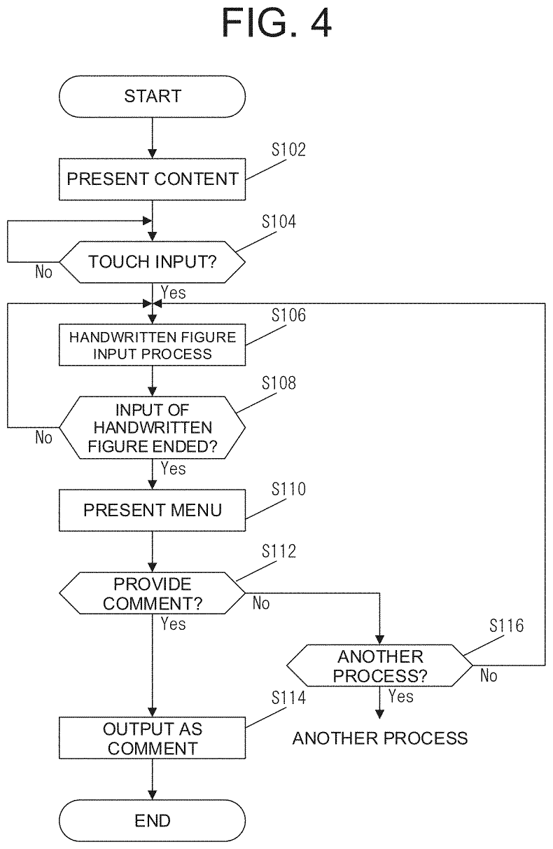

The primary process flow according to the present embodiment is described with reference to the flowchart in FIG. 4. First, the controller 100 causes the display 110 to present content (Step S102). For example, the controller 100 may read the content from the content information 152 or may receive the content via the communicator 160.

The controller 100 determines whether there has been a touch input (Step S104). Specifically, the controller 100 determines that there has been a touch input when a touch-down or a touch-up on the inputter 120 (touch panel) has been detected or when an input with the operating pen on the inputter 120 has been detected.

When there has been a touch input, the controller 100 transitions to a handwritten comment input status (mode) to execute a handwritten figure input process (Yes in Step S104, Step S106). The handwritten comment input status (mode) is a status (mode) where a handwritten figure may be directly input to the displayed content. When the handwritten figure input process is executed, the controller 100 outputs a handwritten figure based on the trajectory of the input to the touch panel. The controller 100 may temporarily output the handwritten figure to the storage 150 until the input ends or may output the handwritten figure to the handwritten figure information 154.

Subsequently, the controller 100 determines whether the input of the handwritten figure has ended (Step S108). Cases where the input of the handwritten figure has ended include the following cases.

(1) Case where a Predetermined Time has Elapsed after a Touch-Up

When a predetermined time has elapsed after the inputter 120 (e.g., the touch panel) detected a touch-up with regard to the user's touch input, the controller 100 determines that the input of the handwritten figure has ended. The predetermined time may be previously set or may be set by the user. The predetermined time is preferably approximately 100 milliseconds to 3 seconds, and more preferably approximately 1 second. Thus, even in a case where touch-downs and touch-ups are detected multiple times due to the successive input of handwritten figures, the controller 100 allows the handwritten figure to be continuously input when a touch-down is detected again before the predetermined time has elapsed.

(2) Case where an Operation Other than the Operation for the Input of a Handwritten Figure is Detected

The operation for the input of a handwritten figure is, for example, the operation (drag operation) for moving the touch position in touch with the touch panel or moving the operating pen in touch. When an operation (e.g., double tap or long press) other than the normal operation for the input of a handwritten figure is detected, the controller 100 determines that the input of the handwritten figure has ended.

(3) Case where the Operation Indicating that the Input of a Handwritten Figure has Ended is Performed

When the user performs the operation indicating that the input of a handwritten figure has ended, the controller 100 determines that the input of the handwritten figure has ended. For example, the controller 100 causes the display 110 to present a button such as “input end” and, when the user selects the button, determines that the input of the handwritten figure has ended.

When it is determined that the input of the handwritten figure by the user has ended, the controller 100 ends the handwritten comment input status (mode) and causes the display 110 to present a menu (Yes in Step S108, Step S110). Specifically, the controller 100 causes the menu to be presented on the upper left or lower right of a rectangular area that is in contact with the outer circumference of the handwritten figure or causes the menu to be presented around the rectangular area. The controller 100 may display the menu with a thick colored frame or flash the displayed menu when a predetermined time has elapsed after the display of the menu. With the display of the menu in such a display mode, the controller 100 may display the menu while allowing the user to easily recognize the menu.

The displayed menu includes the item indicating that the input handwritten figure is to be added to the content as a comment (provided as a comment). As it is possible to make a selection whether to provide a comment via the menu, the user may check whether the series of handwritten figures input from a touch-down until a touch-up for the displayed content is to be added to the displayed content.

Subsequently, after a selection is made via the menu so as to provide a comment (Step S112; Yes), the controller 100 outputs the input handwritten figure as a comment (Step S114). Thus, the controller 100 determines that the handwritten figure input while the handwritten figure input process is executed (while the handwritten comment input status (mode) is set) is the target handwritten figure to be provided as a comment so as to make a comment.

When it is difficult to determine the target handwritten figure to be provided as a comment in a case where all the handwritten figures, which are input before the predetermined time has elapsed after the detection of a touch-down and then a touch-up, are provided as comments, the controller 100 may cause the user to specify the handwritten figure to be provided as a comment. In this case, the controller 100 causes the display 110 to present the screen that prompts the user to designate the handwritten figure to be provided as a comment (for example, the screen for designating the range of the area including the handwritten figure) and, based on the user's designation, determines the handwritten figure to be provided as a comment.

At Step S114, first, the controller 100 determines the target handwritten figure to be provided as a comment. The range including the target handwritten figure to be provided as a comment is identified from the content presented on the display 110, and the image of the content in the range is captured and acquired. The thus acquired image of the content serves as the background of the target handwritten figure to be provided as a comment.

As the range including the handwritten figure, for example, the controller 100 specifies the area (e.g., rectangular area or circular area) that is in contact with the outer circumference of the handwritten figure. As the range including the handwritten figure, the controller 100 may specify the area that is obtained by enlarging the circumference of the area that is in contact with the outer circumference of the handwritten figure by a predetermined size (for example, 10 pixels).

The controller 100 may specify the area that is the range to be captured based on the characteristics of the image of content so as to capture the range with which the characteristics of the image of the content as the background may be determined. For example, the controller 100 specifies the background color of the image of content and divides the image of the content into areas based on the specified background color. The controller 100 specifies, as the area that is the range to be captured, one or more areas including the target handwritten figure to be provided as a comment from the areas in the image of the content. Thus, the controller 100 may acquire, from the image of the content, the image of the content in the area including the handwritten figure and the certain details included in the image of the content.

When the area that is the range to be captured includes an object (e.g., the already input handwritten figure) other than the target handwritten figure to be provided as a comment, the controller 100 may acquire the image where the image of the content and the object are superimposed.

The controller 100 may specify the area that is the range to be captured based on the characteristics of the target handwritten figure to be provided as a comment. For example, when the controller 100 recognizes, as a handwritten figure, a figure including a line extending in a certain direction, such as an arrow or a line, the controller 100 may capture the range so as to include the image of the content included in the area (target area) indicated by the arrow or line in the direction (the direction of one end) indicated by the arrow or line. The direction of one end is, for example, the direction in which the arrowhead is located in a case of an arrow and is the direction in which the distal end (the position where a touch-up is detected) is located in a case of a line. The method for specifying the target area is described below.

Subsequently, the controller 100 outputs, to the storage 150, the image where the acquired image of the content and the handwritten figure input by the user are superimposed.

Due to the above-described process, the controller 100 superimposes the handwritten figure input by the user and the image of the content (i.e., the image that is the background of the handwritten figure) and outputs the handwritten figure and the image as a comment.

The controller 100 adds necessary information to the comment and outputs (stores) the comment to the comment information 156. For example, the controller 100 stores the comment, the ID of the content to which the comment has been added, and the position of the added comment in the comment information 156. The controller 100 sets, as the position of the added comment, for example, a predetermined position on the boundary line of the range including the handwritten figure provided as a comment (any of the four corners in the case of a rectangular area). The controller 100 may set, as the position of the added comment, the center position of the range in which the content is captured, the start position of the input of the handwritten figure, or the position around the start position. When the handwritten figure is temporarily output to the storage 150, the controller 100 may output (store) the handwritten figure to the handwritten figure information 154.

When the user selects another process to be executed instead of providing a comment, the controller 100 executes the selected process (No in Step S112, Yes in Step S116).

When neither process is selected, the controller 100 may transition to the process at Step S106 so as to execute the handwritten figure input process again (No in Step S116, Step S106).

### 1.4 Operation Example

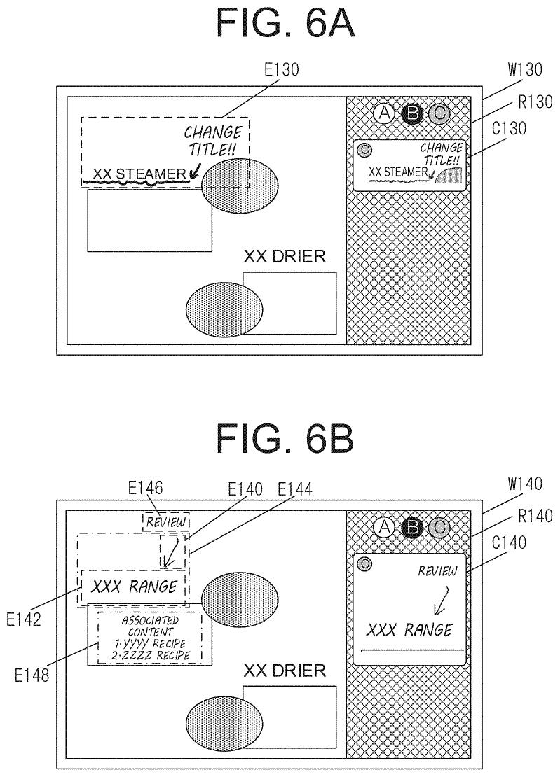

An operation example according to the present embodiment is described with reference to FIGS. 5A to 5C and FIGS. 6A and 6B. FIGS. 5A, 5B, and 5C are diagrams illustrating examples of a display screen presented on the display 110. The display screen W100 illustrated in FIG. 5A is an example of the display screen in a case where the content is presented as a whole and a list of comments is presented on the area R100. The area R100 may be located at any position on the top, bottom, left, or right of the end of the screen. The area R100 may be presented in a superimposed manner on the content in, for example, a window format instead of being located at the end of the screen.

The list of comments added to the content is presented on the area R100. For example, the comment of the user A is presented as a comment C100, and the comment of the user B is presented as a comment C102.

When a list of comments is presented, the comments may be presented such that a parent comment/a child comment are recognizable. For example, the comment C102, which is a child comment of the comment C100, may be presented so as to hang from (presented so as to be nested in) the comment C100 that is a parent comment.

On the display screen W100, a handwritten figure C104 is presented on the content as a handwritten figure input by the user.

After the input of the handwritten figure ends, the display screen presented on the display 110 transitions from the display screen W100 to a display screen W110 illustrated in FIG. 5B. On the display screen W110, a menu M110 is presented near a handwritten figure C114. The user may select the item (“make comment” in the example of FIG. 5B) indicating that the handwritten figure is to be provided as a comment from the menu M110 so as to provide the handwritten figure as a comment. When a selection is made to provide the handwritten figure as a comment, the image where the handwritten figure and the image of the content in the area including the handwritten figure are superimposed is output as a comment. After the comment is output, the display screen presented on the display 110 transitions to a display screen W120 illustrated in FIG. 5C.

On an area R120 for presenting a list of comments on the display screen W120 illustrated in FIG. 5C, the image where the handwritten figure and the image of the content including the handwritten figure are combined is presented as a comment, for example, a comment C120. Thus, the user simply checks the area R120 so as to perceive the input comment and the image of the content for which the comment is provided.

FIGS. 6A and 6B are other diagrams illustrating an operation example. FIG. 6A illustrates an example of a display screen W130 presented on the display 110 in a case where a handwritten figure is input to the portion where the text “XX steamer” is presented as an image of the content. FIG. 6A illustrates that, as a handwritten figure, a line is input under the text “XX steamer” and the arrow and the figures forming the characters indicating “change title!!” are input. An area E130 indicates the rectangular range that is in contact with the outer circumference of the input handwritten figure.

In this case, the image of the content in the range indicated by the area E130 is captured, and the image where the captured image and the handwritten figure are superimposed is output. The comment information including the output image as a comment is output. Accordingly, in the area R130 for presenting the list of comments, the image where the image of the content (the text “XX steamer”) and the handwritten figure are superimposed is presented as a comment like the comment C130 illustrated. The user simply checks the comment C130 to understand that the comment “change title!!” is provided for the text “XX steamer”.

FIG. 6B illustrates an example of a display screen W140 presented on the display 110 in a case where an arrow is input as the target handwritten figure to be provided as a comment. An area E140 included in the display screen W140 indicates the rectangular range that is in contact with the outer circumference of the arrow, which is the handwritten figure to be provided as a comment.

The display screen W140 illustrates that an area E142 and an area E148 are included as an area including a handwritten figure (handwritten character) that is input before the arrow, which is the target handwritten figure to be provided as a comment, is input. The area E142 and the area E148 are located in the direction indicated by the arrow input as a handwritten figure.

In this case, the display device 10 identifies, for example, the area E142 as the target area out of the area E142 and the area E148 that are the areas located in the direction indicated by the arrow.

The display device 10 may determine the image (target image) indicated by the arrow and then identify the area including the target image as the target area. For example, the display device 10 may search for an image present around the position of the arrow from the content images and determine the target image based on the search result. Further, the display device 10 may measure the distance from the character or image closest to the arrow to another character or image adjacent to the character or image and recognize that the target image includes up to the area with the distance larger than a predetermined value. The character searched by the display device 10 may be the text (character) of an object, the character formed by a handwritten figure, or the text (character) included in an image of the content. The display device 10 may determine that the group image including (a set of) images adjacent to the target image is a background. Subsequently, the display device 10 identifies the area including the target image or the group image (for example, the area that is in contact with the outer circumference of the target image or the group image) as the target area.

The display device 10 may use the method of obtaining the distance between objects to determine the target area based on the distance. When it is difficult to determine the target area by using exclusively the distance between objects, the display device 10 may use the method of executing character recognition, semantic recognition, and figure recognition to determine that the range in which the text makes sense is the target area. When it is difficult to automatically make a determination, the display device 10 may display a GUI image (e.g., the screen that allows the designation of the target area) that prompts the user to designate the target area.

The method for specifying the target area may be the combination of methods out of the above-described methods or may be a method other than the above-described methods. The method for specifying the target area may be previously determined or may be selected by the user.

A specific operation example is described with reference to FIG. 6B. First, the display device 10 searches for one character (object of the handwritten figure) present around the position of the arrow. Accordingly, for example, the display device 10 searches for one character among the characters included in the area E142. Subsequently, the display device 10 searches for a character adjacent to the searched character. As the characters included in the area E142 are not widely spaced from each other, the display device 10 may recognize the characters included in the area E142 as the target image with the predetermined value that is appropriately set. As the display device 10 determines that the distance between the characters included in the area E142 and the characters included in the area E148 is wider than the predetermined value, the display device 10 may recognize that the target image includes up to the characters included in the area E142. Thus, the display device 10 identifies the area E142 as the target area out of the area E142 and the area E148 that are located in the direction indicated by the arrow.

After the target area is specified, the display device 10 then specifies the area that is the range for capturing the image of the content by using any of the following methods.

(a) Method for Specifying the Area Including the Area Including the Arrow and the Target Area

The display device 10 specifies the area that includes the area including the arrow and the area in the direction indicated by the arrow and sets the area as the range for capturing the image of the content. For example, the display device 10 specifies the rectangular area that is in contact with the outer circumference of the area including the arrow and the area in the direction indicated by the arrow.

In the example of FIG. 6B, the display device 10 specifies an area E144, which is the rectangular area that is in contact with the outer circumferences of the area E140 and the area E142, as the range for capturing the image of the content and as the target handwritten figure to be provided as a comment.

(b) Method for Specifying Only the Target Area

The display device 10 specifies exclusively the area in the direction indicated by the arrow and sets the area as the range for capturing the image of the content.

In the example of FIG. 6B, the display device 10 specifies exclusively the area E142 as the range for capturing the image of the content.

(c) Method for Also Specifying the Area in the Direction of the Other End of the Arrow

The display device 10 further specifies the area in the direction of the other end that is not the direction indicated by the arrow in addition to the area including the arrow and the target area. The display device 10 sets, as the range for capturing the image of the content, the area including three areas, i.e., the area including the arrow, the target area, and the area in the direction of the other end that is not the direction indicated by the arrow. The display device 10 may specify the area in the direction of the other end by using the same method as the method for specifying the target area.

FIG. 6B illustrates an example of the case where the display device 10 specifies an area E146 as the area in the direction of the other end. In this case, the display device 10 specifies the rectangular area that is in contact with the outer circumferences of the area E140, which is the area including the arrow, the area E142, which is the target area, and the area E146, which is the area in the direction of the other end, as the range for capturing the image of the content. Accordingly, as illustrated in a comment C140 of FIG. 6B, the image where the arrow that is the handwritten figure, the characters located in the directions of one end and the other end of the arrow, and the image of the content in the area including the arrow and the characters, which are the handwritten figures, are superimposed is output as a comment.

Thus, as the display device 10 specifies the target area based on an image or an object in the content, the target area includes a set of images or objects. Further, as the display device 10 acquires the image in the range including the target area, the user may acquire the meaningful target image in the direction indicated by the arrow and may obtain the meaning of the comment more clearly.

Although the arrow is input as a handwritten figure in the case described in FIG. 6B, the image of the content in the direction indicated by a line may be captured when the line is input as a handwritten figure.

According to the present embodiment, the condition (output condition) for outputting a handwritten figure as a comment is that the item for providing the handwritten figure as a comment is selected from the menu displayed after the predetermined time has elapsed since a touch-up; however, other conditions may be used. For example, the condition may be simply that the predetermined time has elapsed after a touch-up without displaying the menu.

When the content includes multiple pages, a comment is added to each page. In this case, the information on the corresponding page is stored in the handwritten figure information 154 and the comment information 156. The UI processor 104 causes the display 110 to present the comment added to the page of the displayed content such that the comment is superimposed on the content or to present a list of comments.

According to the present embodiment, when the display device adds the handwritten figure input by the user as a comment to the content, the display device may output, as a comment, the superimposed image of the handwritten figure and the image of the content in the area including the handwritten figure. Further, the comment information including the thus output image may be output. This allows the user to easily understand for which part of the content the handwritten comment has been input by simply viewing the list of comments.

### 2. Second Embodiment

### 2.1 Process Flow

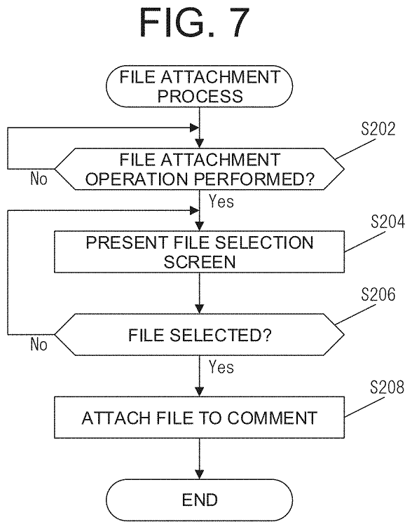

A second embodiment is an embodiment in which a file may be attached to a comment. According to the present embodiment, in addition to the first embodiment, the controller 100 executes a file attachment process illustrated in FIG. 7. According to the present embodiment, the UI processor 104 makes the presentation including the presentation (e.g., clip button) for receiving, from the user, the operation to attach a file to individual comments displayed in a list or a comment selected by the user among the comments displayed in the list. In the present embodiment, the points different from those in the first embodiment are exclusively described below.

First, the controller 100 determines whether the operation has been performed to attach a file (Step S202). The operation to attach a file is, for example, the user's operation to select a clip button that is the presentation for receiving the operation of attaching the displayed file to a comment displayed in the list. In this case, the comment including the clip button selected by the user is the target comment to which a file is attached. The operation to attach a file may be the operation (drag and drop) to drag the file to be attached and drop the file on the comment to which the file is to be attached.

When the operation has been performed to attach a file, the controller 100 performs control to present, on the display 110, a file selection screen for selecting the file to be attached to the comment (Yes in Step S202, Step S204).

The controller 100 causes the file selection screen to be displayed until a file is selected by the user (No in Step S206, Step S204). When a file has been selected by the user, the controller 100 attaches the file selected by the user to the comment (Yes in Step S206, Step S208).

Specifically, the controller 100 associates the comment information 156 corresponding to the target comment to which the file is to be attached with the information on the file selected by the user at Step S206. For example, the controller 100 stores the attached file itself or the storage location (e.g., file path or URL) of the file in the comment information 156 corresponding to the target comment to which the file is to be attached. Any method may be used as long as the comment and the file may be associated with each other, and the controller 100 may use the method of associating and storing the comment ID of the target comment to which the file is attached and the file selected by the user in the storage 150.

When the user performs the operation to display the file attached to the comment, the controller 100 causes the display 110 to present the file attached to the comment in accordance with the user's operation.

### 2.2 Operation Example

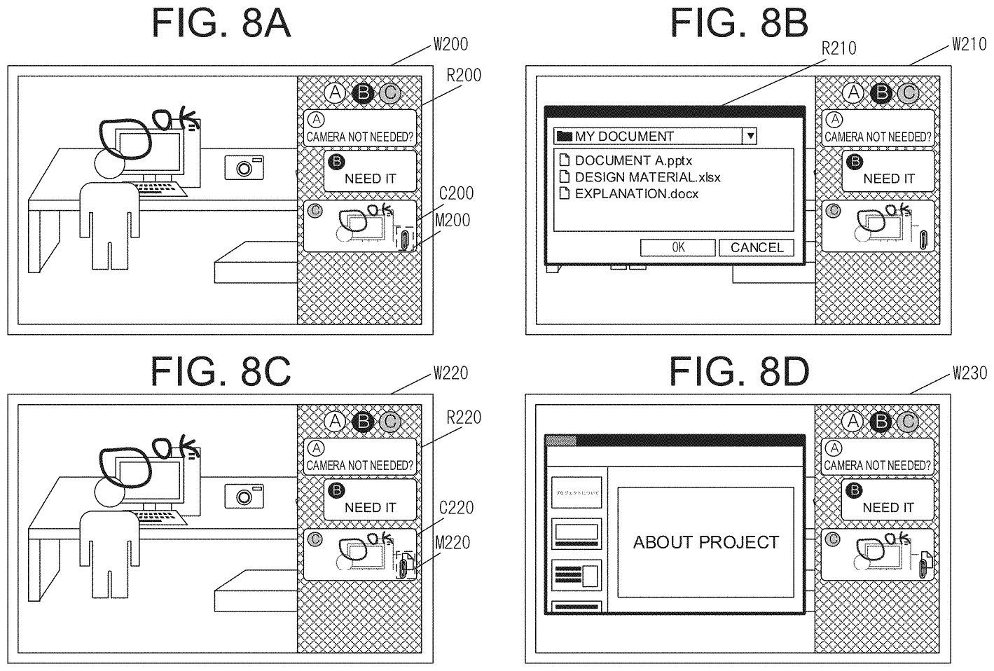

An operation example according to the present embodiment is described with reference to FIGS. 8A to 8D. FIG. 8A is a diagram illustrating an example of a display screen W200 on which the content is displayed. An area R200 for displaying a list of comments is provided at the right end of the display screen W200.

The list of comments added to the content is displayed on the area R200. A clip button M200 is presented for a comment displayed in the list on the area R200, like a comment C200. Although FIG. 8A is a diagram illustrating a case where the clip button M200 is presented for the comment selected by the user, a clip button may be presented for individual comments displayed on the area R200.

When the user performs the operation to select the clip button M200, a display screen W210 including a file selection screen R210 is displayed as illustrated in FIG. 8B. The user selects the file to be attached to the comment from the file selection screen R210.

FIG. 8C is a diagram illustrating an example of a display screen W220 in a case where the file to be attached to the comment is selected by the user. On an area R220 provided at the right end of the display screen W220 and displaying the list of comments, the comment with the file attached thereto is provided with the presentation indicating that the file is attached. For example, like a comment C220 to which the file is attached, a clipping button M220 is presented as the presentation indicating that the file is attached to the comment. In this case, the clipping button M220 may be used as a button for receiving the operation to display the file attached to the comment.

When the clipping button M220 is selected by the user, the file attached to the comment is opened by a predetermined application and a display screen W230 presenting the details of the file is displayed, as illustrated in FIG. 8D.

According to the present embodiment, the user may attach the associated file to a comment. With regard to the attached file, the details of the file may be presented in accordance with an operation on the comment presented in a list. Thus, the user may perceive the comment added to the content and the file associated with the comment simply by viewing the list of comments.

### 3. Third Embodiment

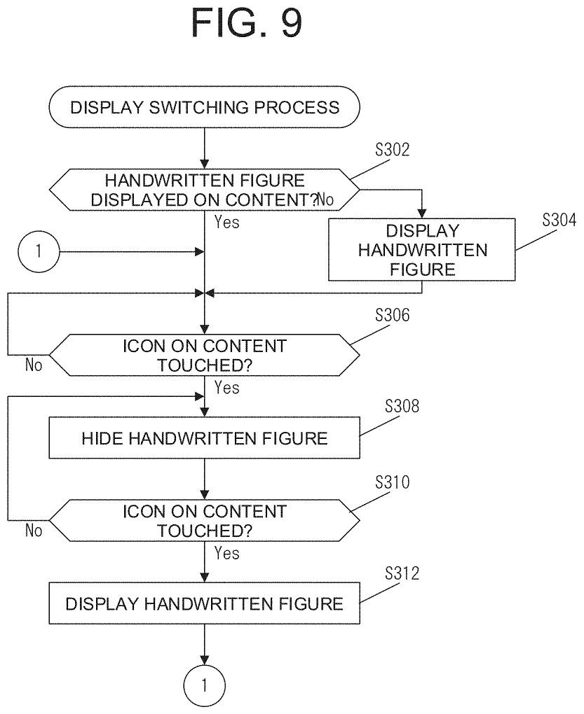

A third embodiment is an embodiment in which the controller 100 performs control to make a switch so as to display or hide a handwritten figure presented on the content in a superimposed manner. According to the present embodiment, in addition to the first embodiment and the second embodiment, the controller 100 executes a display switching process illustrated in FIG. 9. The controller 100 executes the display switching process after the handwritten figure is stored in the handwritten figure information 154 according to the first embodiment and the second embodiment.

In the description according to the present embodiment, displaying and hiding of the handwritten figure are switched for each user. When the controller 100 outputs a handwritten figure to the handwritten figure information 154, the controller 100 associates and outputs the handwritten figure and the user who has input the handwritten figure by using, for example, the method for performing the process to output the handwritten figure information 154 on each user. The user who has input the handwritten figure may be determined by, for example, using the input device 15, may be determined based on the display device with which the operation has been performed to input the comment, or may be determined by performing a switching operation at the time of input.

According to the present embodiment, when a handwritten figure is displayed on the content in a superimposed manner, the controller 100 causes the identification presentation indicating the user who has input the handwritten figure to be displayed near the handwritten figure. The displayed identification presentation is, for example, the icon indicating a user or the label or the button presenting a user name and, in the description according to the present embodiment, the icon indicating a user is presented as an identification presentation.

### 3.1 Process Flow

The display switching process is described with reference to FIG. 9. First, when no handwritten figure is displayed on the content, the controller 100 reads the handwritten figure information 154 and displays the read handwritten figure on the content in a superimposed manner (No in Step S302, Step S304). The controller 100 also causes the icon indicating the user who has input the handwritten figure to be displayed near the handwritten figure (for example, the position where a comment is added).

Subsequently, the UI processor 104 determines whether a touch input has been made to the icon indicating the user displayed on the content (Step S306). When it is determined that a touch input has been made to the icon on the content, the controller 100 hides the handwritten figure input by the user indicated by the selected icon (Yes in Step S306, Step S308).

Specifically, the controller 100 identifies the user indicated by the icon to which a touch input has been made and refrains from reading the handwritten figure information input by the identified user from the handwritten figure information 154. Then, the controller 100 presents the handwritten figure again to prevent the handwritten figure input by the user indicated by the selected icon from being displayed on the content in a superimposed manner. The controller 100 keeps the icon on the content displayed.

Subsequently, the controller 100 determines whether a touch input has been made to the icon on the content selected by the user at Step S306 (Step S310). When it is determined that a touch input, which is the operation to select an icon on the content, has been made, the controller 100 causes the handwritten figure input by the user indicated by the selected icon to be displayed (Yes in Step S310, Step S312). Specifically, the controller 100 reads a handwritten figure from the handwritten figure information 154 corresponding to the user indicated by the icon to which a touch input has been made and causes the read handwritten figure to be displayed on the content presented on the display 110 in a superimposed manner.

After performing the process at Step S312, the controller 100 may proceed to the process at Step S306 so as to perform the process to hide the handwritten figure again.

### 3.2 Operation Example

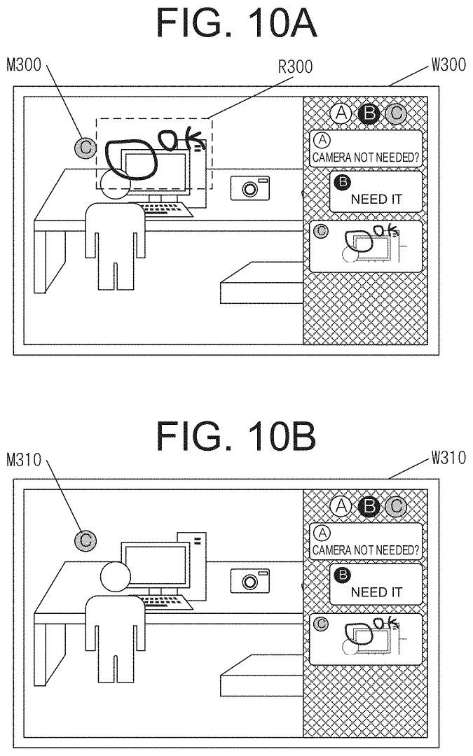

An operation example according to the present embodiment is described with reference to FIGS. 10A and 10B. FIG. 10A is a diagram illustrating an example of a display screen W300 in which a handwritten figure is displayed on the content in a superimposed manner. An area R300 illustrated in FIG. 10A is an area including a handwritten figure input by the user C. An icon M300 indicating the user C is presented as an identification presentation near the handwritten figure input by the user C. For example, as illustrated in FIG. 10A, the icon M300 is presented around the area R300 including the handwritten figure input by the user C.

When the touch input, which is the operation to select the icon M300, is detected, a display screen W310 in which the handwritten figure input by the user C is hidden is displayed as illustrated in FIG. 10B. An icon M310 indicating the user C is displayed.

When the touch input, which is the operation to select the icon M310, is detected on the display screen W310, the handwritten figure input by the user C is displayed, and the display screen like the display screen W300 illustrated in FIG. 10A is displayed again. Thus, each time the icon indicating the user C is selected, it is possible to make a switch to display or hide the handwritten figure input by the user C.

According to the present embodiment, the user may perform a simple operation of selecting the identification presentation to make a switch so as to display or hide a handwritten figure that is generally difficult to hide or needs a complicated operation to hide. This allows the user to always ensure the area for inputting a handwritten figure.

In the description according to the present embodiment, displaying and hiding of a handwritten figure are switched for each user; however, displaying and hiding of a handwritten figure may be switched for each comment, or displaying and hiding of a handwritten figure may be collectively switched for all the comments. To switch displaying and hiding of a handwritten figure for each comment, the storage 150 may store the handwritten figure information 154 for each comment. The UI processor 104 may read the handwritten figure information 154 corresponding to the comment other than the selected comment to be hidden and displays the handwritten figure stored in the read handwritten figure information 154 on the content in a superimposed manner.

### 4. Fourth Embodiment

### 4.1 Overall Configuration

FIG. 1A is a diagram illustrating the external appearance of the display device 10. The display device 10 may be, for example, an information processing device, such as a tablet terminal device or a laptop computer, a large-sized display device such as a display device used in an electronic whiteboard or an electronic blackboard (interactive whiteboard (IWB)), or a table display device. A user's operation on the display device 10 is input, for example, when a touch on a touch panel is detected or an operation using the input device 15 is detected.

In this system, the display device 10 stores content and a comment. The display device 10 may refer to the stored content or comment so as to add the comment to the content and display the comment.

Although the display device 10 is described as a single device according to the present embodiment, it is possible to have the configuration including a plurality of display devices or the configuration in which a display device and a server work in cooperation with each other.

For example, as illustrated in FIG. 1B, it is possible to use the configuration of a system including the display device 10H used by the user H who is an administrator and a plurality of display devices used by other users. The outline of an operation of the entire system is described below.

(1) With the display device 10H used by the user H who is an administrator, the user H selects a content (F10). The user H may add a comment to the content by himself/herself. The comment may be stored as a file (data) separately from the content.

(2) With the display device 10A used by the user A, the user A reads the content and the comment as appropriate from the display device 10H (F12).

(3) The user A performs the process to add a comment to the read content (F14).

(4) The comment added to the content by the user A is transmitted to the display device 10H (F16). The display device 10H updates the comment corresponding to the content based on the received comment so that the comment added by the user A is applied to the content.

(5) In the same manner, the user B and the user C also perform the process to add a comment to the content selected by the user H.

Thus, the use of this system allows each user to add a comment to the content.

The display device may be a system that is connectable to a server device. For example, as illustrated in FIG. 1C, the server device 20 capable of communicating with the display device 10 is connected to the system.

The server device 20 may be in the same network or in the cloud. As illustrated in FIG. 1C, each of the display devices 10 is configured to be able to communicate with the server device 20. Specifically, the content stored in the display device 10H and the data regarding the comment in the configuration of FIG. 1B are stored in the server device 20. The display device 10H, the display device 10A, and the display device 10B refer to the server device 20 so as to perform the same operation as the operation in the above-described configuration.

Although a single display device works in the case described below, what is called a person skilled in the art may also apply it to a second configuration and a third configuration.

### 4.2 Functional Configuration

The comment processor 102 processes the object input by the user as a comment input for the content. Examples of objects input by the user include figures, text (characters), and symbols.

The controller 100 is a functional unit that performs the overall control on the display device 10. The controller 100 reads and executes various programs stored in the storage 150 to perform various functions and includes, for example, one or more arithmetic devices (e.g., central processing units (CPUs))

The controller 100 executes a program to operate as the comment processor 102, the user interface (UI) processor 104, and the user authenticator 106.

The comment processor 102 executes editing processing such as inputting, changing, or deleting of a comment in accordance with an operation input by the user. The comment processor 102 adds necessary information to the comment input by the user and stores the comment in comment information 156 of the storage 150. When the other display device 10 or the server device 20 stores comment information, the comment processor 102 may transmit and receive a comment to and from the other device via the communicator 160.

The comment processor 102 processes the object input by the user as a comment input for the content. Examples of objects input by the user include figures, text (characters), and symbols.

According to the present embodiment, the content is content presented on the display 110 of the display device 10 and is, for example, an image or a document. The document refers to data generated by using word-processing software, spreadsheet software, or presentation software or Portable Document Format (PDF) data.

According to the present embodiment, the comment refers to information that is input by the user so as to be associated with the content and refers to information that is associated with the information on the user who has input the content and the information on the content presented when the content is input. The information input as a comment by the user may be information to be sent to other users, such as a note or feedback for the content or may be private information such as a memorandum.

With regard to the input of an object, for example, the comment processor 102 receives the input of text as a comment when the user makes the input via a software keyboard or a hardware keyboard. The comment processor 102 receives the input figure as a comment when the figure is drawn on the touch panel or the figure is drawn with an operating pen. In the following description, the figure input by a touch operation on the touch panel or an operation with the operating pen is referred to as a handwritten figure. Examples of the handwritten figure include the figure forming a character or a symbol and a figure such as point, line, arrow, or rectangle.

The comment processor 102 may receive an input while switching between a text comment and a figure comment in accordance with a touch button or an operation.

The comment processor 102 may recognize a handwritten figure as a character to convert the handwritten figure into text or may generate text as an image. According to the present embodiment, the user may add a comment without being aware of a text input and a handwritten input.

The comment processor 102 may process an image such as a stamp as a comment added by the user.

The comment processor 102 may perform other general editing processes such as operations for insertion, deletion, modification, replacement, and movement, and known editing processes such as change in a character type, movement of a cursor, change in a font, and change in the color/thickness of a line, and modification of a line.

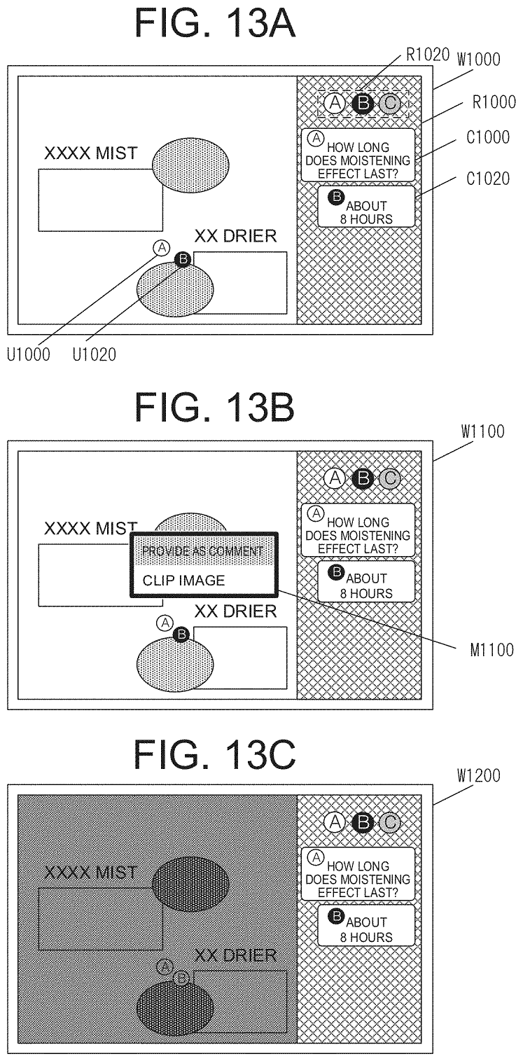

The UI processor 104 generates a user interface screen and displays the user interface screen on the display 110. According to the present embodiment, the UI processor 104 performs the process to display content, information about a comment, and a list of comments on the display 110. For example, as illustrated in FIG. 13A, the content is displayed on an entire display screen W1000, and comments are vertically arranged and displayed as a list on an area R1000. Comments may be arranged in chronological order or may be displayed on a per user basis. For example, user icons are displayed on an area R1020 of FIG. 13A. When the user selects a user icon, the UI processor 104 reads the comment corresponding to the selected user from the comment information 156 and displays the comment. The UI processor 104 may display a list of comments so as to be superimposed on the content or may divide the display area of the display 110 and display the list of comments in an area different from the area where the content is displayed. The UI processor 104 may selectively display or hide a list of comments.

The user authenticator 106 authenticates a user. Specifically, the user authenticator 106 refers to the user information 158 to, for example, authenticate the user who adds a comment or authenticate the owner (user) of the content. The user authenticator 106 may use an external authentication server. When the authentication server is used, the user authenticator 106 and the user information 158 may be stored in the authentication server.

The display 110 presents content and comments and presents various statuses of the display device 10 and the status of an operation input. The display 110 includes, for example, a liquid crystal display (LCD), an organic EL panel, or electronic paper using an electrophoresis system.

The inputter 120 receives an operation input from the user. The inputter 120 includes, for example, a capacitive or pressure-sensitive touch panel. The inputter 120 may include the combination of a touch panel and an operating pen or may be an input device such as a keyboard and a mouse. Furthermore, the inputter 120 may be appropriate as long as the user is able to input information, such as voice input in combination with a microphone, or the like.

The inputter 120 detects the position of the input operation performed by the user and outputs the position as an input position to the controller 100. The input position is preferably, for example, the coordinates on the display screen presented on the display 110 as the position detected on the touch panel. The input position may be the position of a cursor (the position of a row or a column in a sentence) or the position of the provided layout information (for example, above a button or above a scroll bar).

The storage 150 is a functional unit that stores various programs and various types of data needed for an operation of the display device 10. The storage 150 includes, for example, a solid state drive (SSD), which is a semiconductor memory, or a hard disk drive (HDD). The storage 150 stores the content information 152, the handwritten figure information 154, the comment information 156, and the user information 158.

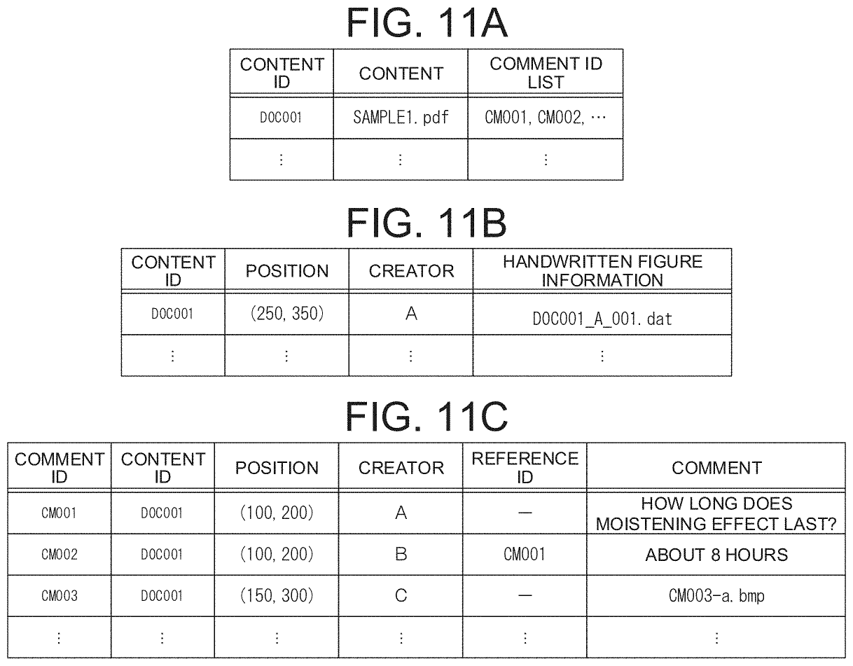

As the content information 152, content and the information about the content are stored. For example, as illustrated in FIG. 11A, the content information 152 includes the following information.
Content ID: the information for identifying content.
Content: the information about content. Examples of the content include a text file, an image file, a Portable Document Format (PDF) file, and an Office file. As these contents, the actual data may be stored, or the storage location (for example, the location of a folder, a uniform resource locator (URL)) may be stored. The content may include one or more pages.
Comment ID list: a list of comment IDs. The comment ID corresponding to the comment added to the content is included.

As the handwritten figure information 154, the information about the handwritten figure input for the content is stored. The handwritten figure input for the content refers to a handwritten figure directly input for the content by the user's touch operation, operation with an operating pen, or the like, on the area where the content is displayed.

The handwritten figure information 154 includes the following information, for example, as illustrated in FIG. 11B.
Content ID: the information for identifying content.
Position: the position associated with the area in which a handwritten figure is input. The position is a position in the content or in a page of the content and, for example, is indicated as coordinates (XY coordinates).
Creator: the information about the user who has input the handwritten figure.
Handwritten figure information: the information indicating the handwritten figure.

As the position stored in the handwritten figure information 154, the position inside or around the area including the handwritten figure is stored. Handwritten figure information stored in the handwritten figure information 154 may be stored as a raster image or a vector image.

As the comment information 156, a comment added to content by the user and the information about the content are stored. For example, as illustrated in FIG. 11C, the comment information 156 includes the following information.
Comment ID: the information for identifying a comment.
Content ID: the information for identifying the content corresponding to the comment.
Position: the information on the position where the comment is added in the content. The position is a position in the content or in a page of the content and, for example, is indicated as coordinates (XY coordinates). When the content is sentence data such as text data, the position may be represented by using a row and a column.
Creator: the information about the creator of the comment.
Reference ID: the information for identifying the comment (parent comment) referred to by the comment. When the user adds comments hierarchically, the parent comment ID is stored so as to identify the parent comment. Related comments that are parent and child comments are expressed as a comment group.
Comment: the information indicating the details of the comment actually input (added) by the user. For example, text data, image data, data regarding an attached file, and the like, are stored as the details.

Multiple details may be stored as comments. For example, image data and text data may be stored or multiple sets of image data may be stored as comments. When multiple sets of data are stored as comments, the storage order (input order) may be retained. For example, a first input image (first image) and a second input image (second image) may be stored as comments while the order is retained. In this case, the comment processor 102 may treat the second image as a comment (information associated with the first image) as an additional note for the first image.

As the user information 158, the information about a user is stored. As the information for identifying the user, for example, the login ID of each user, the password, the name, the terminal used, the biometric information on the user, and the ID of the pen used for input may be stored. The user information 158 is stored in association with the icon of each user.

The communicator 160 communicates with other devices. For example, the communicator 160 connects to a local area network (LAN) to transmit and receive the information about a comment or transmit and receive a document to and from other devices. As a communication method, communications such as LTE/4G/5G may be used as well as a general LAN for Ethernet (registered trademark).

For each of the above-described configurations, the display device 10 may have a function as appropriate. For example, when each set of data is stored in the display device 10 used by a user (general user) who is not an administrator or the server device 20, the content information 152 and the comment information 156 do not need to be stored in the storage 150. Various types of information may be stored in a server on the cloud as appropriate.

The configuration illustrated in FIG. 2 is appropriate as long as the configuration includes at least the controller 100 and the storage 150 and has any configuration that enables the operation according to the present embodiment. Some functions may be performed by an external device. For example, the display 110 may be configured as an external device such as a display. That is, the display device 10 may include a display device and a terminal device, and the terminal device may include the controller 100 and the storage 150.

### 4.3 Process Flow

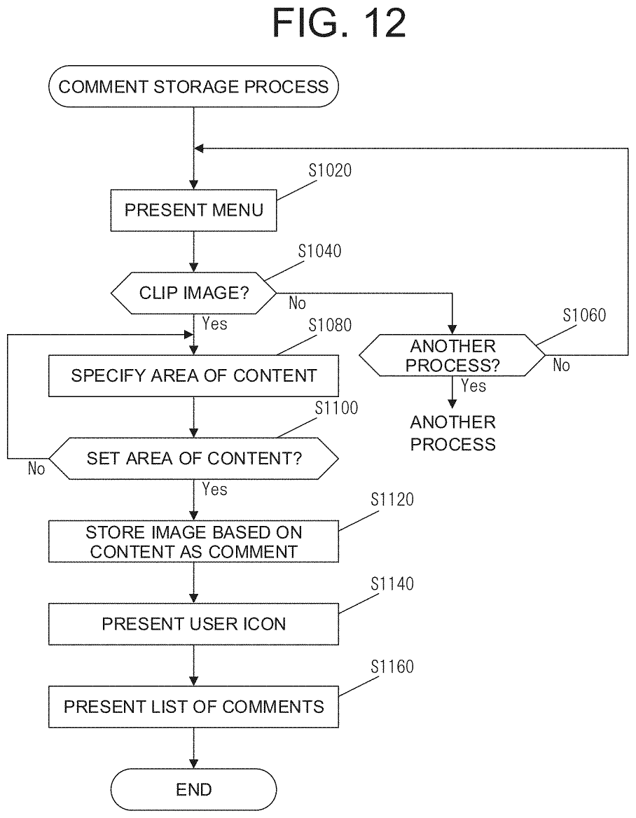

The flow of a comment storage process according to the present embodiment is described with reference to FIG. 12. The controller 100 executes the comment storage process illustrated in FIG. 12 after a user interface screen for performing the process to display content and a comment is generated by the UI processor 104 and is presented on the display 110.

First, the controller 100 causes the display 110 to present a menu (Step S1020). The controller 100 causes the menu to be presented when a gesture, such as long press or double tap, or the operation of selecting an icon or a button for displaying the menu is input via the inputter 120.

The menu displayed at Step S1020 presents one or more items indicating the processes that are executable by the controller 100. The user may select one item from the menu to execute a predetermined process. According to the present embodiment, the items included in the menu displayed at Step S1020 include “clip image” that is the process to acquire part of the content as an image and output the acquired image (target image) as a comment.

The controller 100 determines whether “clip image” has been selected from the menu (Step S1040). When “clip image” has not been selected from the menu and the item indicating another process has been selected, the controller 100 executes the selected process (No in Step S1040, Step S1060).

Conversely, when “clip image” has been selected from the menu, the controller 100 specifies an area of the content based on the operation input via the inputter 120 (Yes in Step S1040, Step S1080).

For example, the controller 100 causes the display 110 to present the screen that receives the input of a touch operation, an operation with an operating pen, and a drag operation due to a mouse operation from the user via the inputter 120 and enables designation of an area by the received drag operation. When the user performs a drag operation, the controller 100 specifies the area based on the drag operation in the content presented on the display 110.

The area specified by the controller 100 may be a rectangular area or a circular area or may be a free-form area whose boundary is the position of the drag operation itself.

Subsequently, the controller 100 determines whether the specified area of the content is to be set (Step S1100). For example, the controller 100 causes the display 110 to present the menu for selecting whether to set the area when a drop operation is detected, i.e., a drag operation has ended. When the user has made a selection to set the area, the controller 100 determines that the specified area of the content is to be set.

The controller 100 may set the specified area of the content as it is without displaying the menu, or the like, when it is detected that a drag operation has ended. The controller 100 may set the specified area of the content if no operation is input by the user before a predetermined time (e.g., three seconds) elapses after it is detected that a drag operation has ended.

When the area of the content is not set, the controller 100 returns to Step S1080 (No in Step S1100, Step S1080).

Subsequently, when the area of the content is set at Step S1100, the controller 100 acquires the image based on the content in the specified area and stores the image as a comment (Yes in Step S1100, Step S1120).

In order to acquire the image based on the content, the controller 100 generates the image to be stored as a comment from the content presented on the display 110. For example, the controller 100 captures (clips) the area set at Step S1100 to acquire the image based on the content. When the captured area includes the object (for example, the handwritten figure directly input to the content), the controller 100 may acquire the image in which the image based on the content and the object are superimposed.

The controller 100 generates comment information that includes the content ID of the content including the acquired image as a comment and presented on the display 110, the comment ID, the position, and the creator and stores the comment information as the comment information 156. Thus, the image based on the content on the basis of the area selected by the user is stored as a comment.

The controller 100 sets a serial number, a character string generated according to a predetermined rule, or a random character string as the comment ID stored as the comment information 156.

The controller 100 sets, for example, the input position of a gesture, such as long press or double tap, during the display of the menu at Step S1020 as the position to be stored as the comment information 156. The controller 100 may set the end position of a drag operation as the position to be stored as the comment information 156, may make the user select the position, or may determine the position based on the captured area. The position determined based on the captured area may be, for example, the center of the captured area or may be any of the four corners of a rectangular area when the captured area is a rectangular area.

The controller 100 may make the user previously select the creator to be stored as the comment information 156 before the menu is presented at Step S1020 or may identify the creator based on the operating pen used when the user inputs the area of the content at Step S1080.

Subsequently, the controller 100 (the UI processor 104) reads the comment information 156 and causes the display 110 to present the user icon as the identification presentation indicating the user (creator) who has added the comment at the position where the comment has been added (Step S1140). The user icon is one type of identification presentation for identifying the user (creator) who has added a comment and refers to a figure, symbol, character, or image for identifying the user who has added a comment. The identification presentation may be any presentation as long as it is possible to identify the user who adds a comment.

The controller 100 (the UI processor 104) performs the process to cause the display 110 to present a list of comments (Step S1160). When the vertical length or the horizontal length of a partial image of the content stored as a comment is large, the controller 100 (the UI processor 104) may display the reduced-size partial image of the content.

Thus, as the partial image of the content is stored as a comment, the user may view the comment presented in a list on the display 110 so as to perceive the image based on the content in the target area to be added as a comment. As the comment processor 102 executes an editing process, the user may edit or delete a comment.

### 4.4 Operation Example

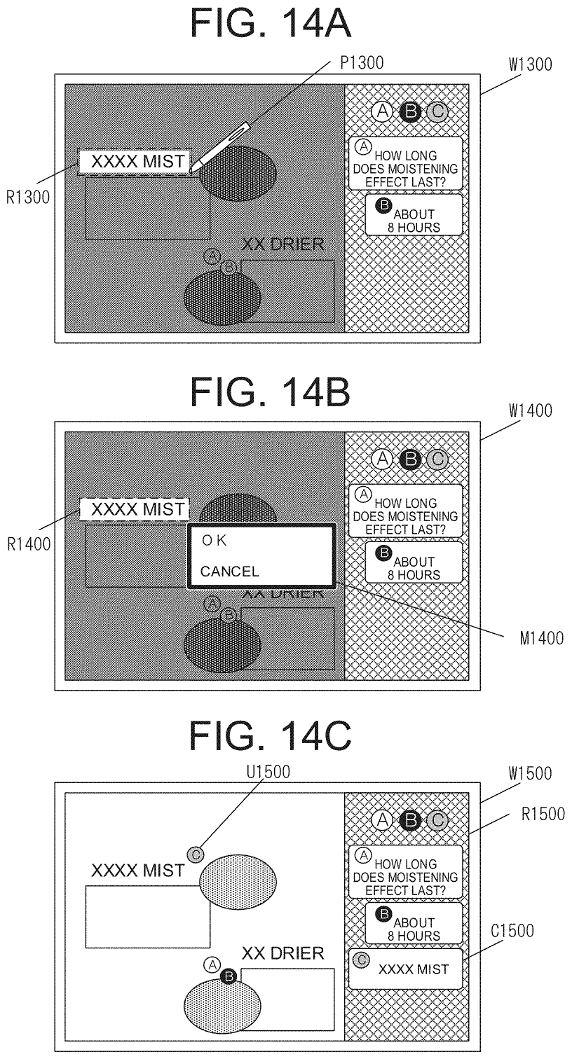

An operation example according to the present embodiment is described with reference to FIGS. 13A to 13C and 14A to 14C. First, a display screen W1000, which is a user interface generated by the UI processor 104, is described with reference to FIG. 13A. On the display screen W1000, the content is presented on the entire displayable area of the display 110, and a list of comments is presented on an area R1000 on the right end of the screen. The area R1000 may be located at any position on the top, bottom, left, or right of the end of the screen. The area R1000 may be presented in a superimposed manner on the content in, for example, a window format instead of being located at the end of the screen.

The list of comments added to the content is presented on the area R1000. For example, the comment of the user A is presented as a comment C1000, and the comment of the user B is presented as a comment C1020. On the display screen W1000, as indicated by a user icon U1000 and a user icon U1020, the user icons are presented at the positions where comments have been added.

When a list of comments is presented, the comments may be presented such that a parent comment/a child comment are recognizable. For example, the comment C1020, which is a child comment of the comment C1000, may be presented so as to hang from (presented so as to be nested in) the comment C1000 that is a parent comment.

Next, the display screen presented on the display 110 when the controller 100 executes a comment storage process is described. First, when the process is performed to present the menu at Step S1020 during the comment storage process, the display 110 presents a display screen W1100 illustrated in FIG. 13B. The display screen W1100 presents a menu M1100. The menu M1100 includes an item “clip image”. Out of the items presented in the menu M1100, an item unselectable by the user may be grayed out.

When “clip image” is selected from the menu presented on the display screen W1100, the display screen presented on the display 110 transitions from the display screen W1100 to a display screen W1200 illustrated in FIG. 13C. As illustrated in FIG. 13C, the display screen W1200 presents the content in a dark color such that the entire content is blacked out.

FIG. 14A illustrates a display screen W1300 that is displayed when the user performs an operation in the above situation. For example, when a drag operation using an operating pen P1300 is input by the user, the area specified by the display device 10 based on the drag operation may be displayed in a bright color as illustrated in an area R1300 of FIG. 14A. Thus, the display device 10 allows the user to confirm the area of the content to be stored as a comment.

When the display device 10 detects that the drag operation has ended on the display screen W1300, the display screen presented on the display 110 transitions from the display screen W1300 to a display screen W1400 illustrated in FIG. 14B. The display screen W1400 presents a menu M1400. The menu M1400 includes, as items, “OK” for setting the area specified based on the operation input by the user and “cancel” for reselecting an area. When the user selects “cancel” from the menu M1400, the display screen presented on the display 110 transitions from the display screen W1400 to the display screen W1200 illustrated in FIG. 13C. It is also possible to transition to the display screen W1300 illustrated in FIG. 14A so as to receive the operation to modify the specified area (for example, a brightly displayed area such as the area R1300).

Conversely, when the user selects “OK” from the menu M1400, the display screen presented on the display 110 transitions from the display screen W1400 to a display screen W1500 illustrated in FIG. 14C. The display screen W1500 is a display screen where the image based on the content in the area (the area R1300 in FIG. 14A) specified based on the user's operation is newly stored as a comment.

For example, as the image of the content based on the area R1300 of FIG. 14A, which is the area specified based on the user's operation, the image of the content in the rectangular area indicated by an area R1400 in FIG. 14B is captured and is stored as a comment. Accordingly, as a partial image of the content, the image that captures the range of the area R1400 is newly stored as a comment. For example, on an area R1500 where a list of comments is presented, as indicated by a comment C1500, the newly stored comment (the image of the content in the area R1400) is presented in the list of comments. A user icon U1500 is presented at the position where the comment C1500 has been added.

According to the present embodiment, the display device specifies the area of the content based on the input from the user, acquires the content based on the specified area, and stores the content as a comment. Thus, the user may select the area of the content so as to store the content based on the selected area as a comment.

### 5. Fifth Embodiment

Next, a fifth embodiment is described. The fifth embodiment is an embodiment in which a comment may be further added to the image based on the content stored as a comment.

### 5.1 Process Flow

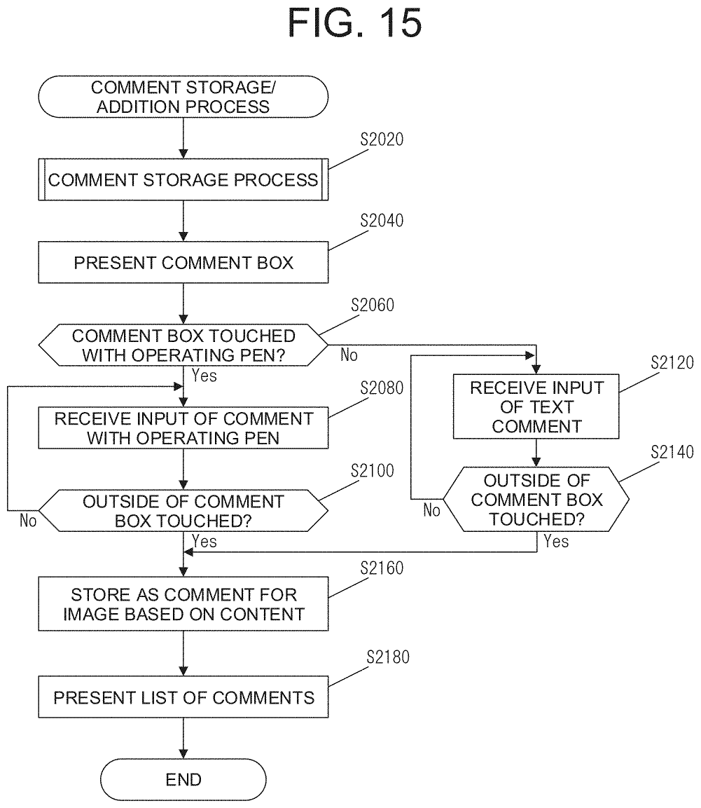

According to the present embodiment, the controller 100 executes a comment storage/addition process illustrated in FIG. 15. The controller 100 executes the comment storage/addition process illustrated in FIG. 15 after a user interface screen for performing the process to display content and a comment is generated by the UI processor 104 and presented on the display 110.

First, the controller 100 executes the comment storage process described in the fourth embodiment (Step S2020). Accordingly, the controller 100 stores the content based on the area specified on the basis of the user's operation as a comment. The controller 100 (the UI processor 104) causes the display 110 to present the user icon based on the comment stored during the comment storage process.

Subsequently, the controller 100 causes the display 110 to present a comment box (Step S2040). The comment box is an area that is presented on the content displayed on the display 110 in a superposed manner and is an area (input area) for receiving the input of a comment (object) in accordance with a touch operation or an operation with an operating pen. In the description according to the present embodiment, the comment box presented at Step S2040 is displayed to input a comment for the comment stored at Step S2020.

Subsequently, the controller 100 determines whether the comment box has been touched with the operating pen (Step S2060). When the comment box has been touched with the operating pen, the controller 100 receives the input of a comment (handwritten figure) with the operating pen (Yes in Step S2060, Step S2080). This allows the user to input a comment (handwritten figure) to the comment box.

Subsequently, the controller 100 determines whether the outside of the comment box has been touched (Step S2100). When the outside of the comment box has not been touched, the input of a comment with the operating pen is continuously received (No in Step S2100, Step S2080).

When the outside of the comment box has been touched, the controller 100 stores the comment input to the comment box as an additional comment for the comment (the image based on the content) stored at Step S2020 (Yes in Step S2100, Step S2160).

For example, when the input of a comment with the operating pen is received at Step S2080, the controller 100 stores the comment information 156 in which the comment (the partial image of the content) stored at Step S2020 is a first image and the image of the comment (handwritten figure) based on the input with the operating pen is a second image. Thus, the controller 100 may store the image of the comment input to the comment box using the operating pen as a comment for the image based on the content.

When it is not determined at Step S2060 that the comment box has been touched with the operating pen, the controller 100 receives the input of a text comment (No in Step S2060, Step S2120). For example, the user inputs text to the comment box by using a keyboard, or the like.

Subsequently, the controller 100 determines whether the outside of the comment box has been touched (Step S2140). When the outside of the comment box has not been touched, the input of a text comment is continuously received (No in Step S2140, Step S2120).

When the outside of the comment box has been touched, the controller 100 stores the comment input to the comment box as a comment for the comment (the image based on the content) stored at Step S2020 (Yes in Step S2140, Step S2160). For example, the controller 100 adds the text of the received input at Step S2120 to the comment in the comment information 156 stored at Step S2020 and stores the comment. Accordingly, the controller 100 may store the text comment input to the comment box as an additional comment to the image based on the content.

Subsequently, the controller 100 (the UI processor 104) causes the display 110 to present a list of comments (Step S2180). Accordingly, the image based on the content stored at Step S2020 and the comment input to the comment box are presented as a group on the display 110.

### 5.2 Operation Example

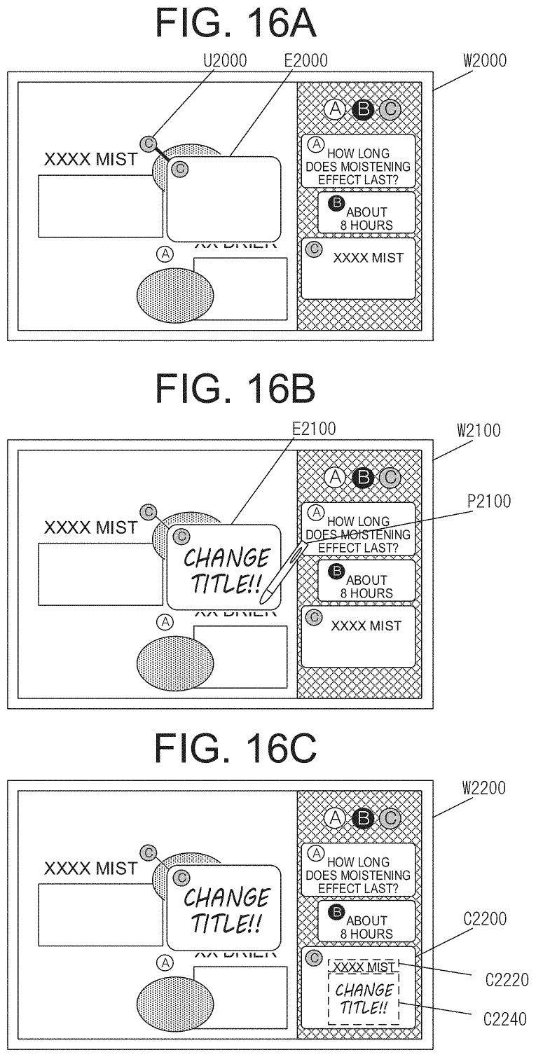

An operation example according to the present embodiment is described with reference to FIGS. 16A to 16C. FIG. 16A is a diagram illustrating a display screen W2000 presented on the display 110 when the process is performed to present a comment box. The display screen W2000 presents a user icon U2000 and a comment box E2000. The comment to be added may be presented such that a line, or the like, connecting the user icon U2000 and the comment box E2000 is indicated.

FIG. 16B is a diagram illustrating a display screen W2100 presented on the display 110 when a comment (handwritten figure) is input to a comment box E2100 by using an operating pen P2100. This allows the user to input, via the comment box E2100, a comment for the image based on the content on the basis of the area selected in accordance with, for example, a touch operation or an operation with the operating pen.

FIG. 16C is a diagram illustrating a display screen W2200 presented on the display 110 when the outside of the comment box has been touched. The comment input to the comment box is confirmed in accordance with a touch on the outside of the comment box. In a comment C2200 presented on the display screen W2200, a partial image C2220 of the content stored as a comment and an image C2240 of the comment input to the comment box are presented. The user may view the comment C2200 so as to check for which part of the content the comment has been input by the user.

According to the present embodiment, the display device may receive the input of a comment for a partial image of the content stored as a comment and may store the input comment as a comment for the partial image of the content. Thus, as the partial image of the content and the comment for the partial image of the content are displayed as a list, the user may perceive the details of the comment for the content and the details of the content to which the comment is added.

### 6. Sixth Embodiment

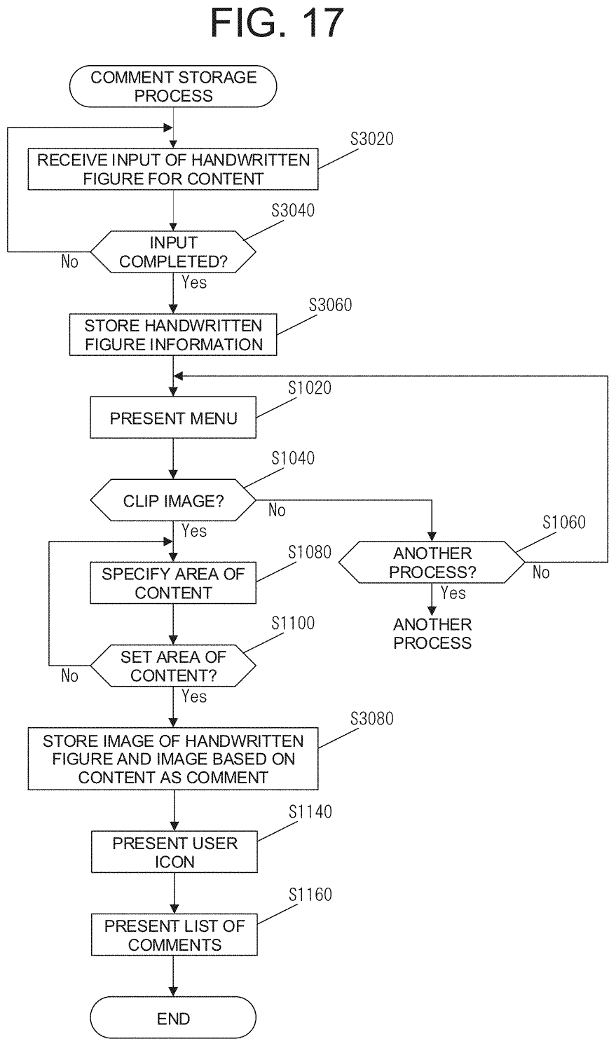

Next, a sixth embodiment is described. The sixth embodiment is an embodiment in which, contrary to the fifth embodiment, the input of an object is first received and then an area of the content to be stored as a comment is selected. The present embodiment is an embodiment in a case where, particularly, the first received comment is a handwritten figure that is directly input to the content. FIG. 12 according to the fourth embodiment is replaced with FIG. 17 according to the present embodiment. The same functional units and processes are denoted by the same reference numeral, and the description thereof is omitted.

### 6.1 Process Flow

According to the present embodiment, the controller 100 executes the comment storage process illustrated in FIG. 17. The controller 100 executes the comment storage process illustrated in FIG. 17 after a user interface screen for performing the process to display content and a comment is generated by the UI processor 104 and is presented on the display 110.

First, the controller 100 receives the input of a handwritten figure for the content (Step S3020). For example, when a touch-down on the inputter 120 (touch panel) is detected or an input to the inputter 120 with the operating pen is detected, the controller 100 transitions to the handwritten comment input status (mode) to receive the input of the handwritten figure.

The handwritten comment input status (mode) is a status (mode) where a handwritten figure may be directly input to the displayed content. When the handwritten figure input process is executed, the controller 100 outputs a handwritten figure based on the trajectory of the input to the touch panel. The controller 100 may temporarily output the handwritten figure to the storage 150 until the input ends or may output the handwritten figure to the handwritten figure information 154.

Subsequently, the controller 100 determines whether the input of the handwritten figure has ended (Step S3040). Cases where the input of the handwritten figure has ended include the following cases.

(1) Case where a Predetermined Time has Elapsed after a Touch-Up

When a predetermined time has elapsed after the inputter 120 (e.g., the touch panel) detected a touch-up with regard to the user's touch input, the controller 100 determines that the input of the handwritten figure has ended. The predetermined time may be previously set or may be set by the user. The predetermined time is preferably approximately 100 milliseconds to 3 seconds, and more preferably approximately 1 second. Thus, even in a case where touch-downs and touch-ups are detected multiple times due to the successive input of handwritten figures, the controller 100 allows the handwritten figure to be continuously input when a touch-down is detected again before the predetermined time has elapsed.

(2) Case where an Operation Other than the Operation for the Input of a Handwritten Figure is Detected

The operation for the input of a handwritten figure is, for example, the operation (drag operation) for moving the touch position in touch with the touch panel or moving the operating pen in touch. When an operation (e.g., double tap or long press) other than the normal operation for the input of a handwritten figure is detected, the controller 100 determines that the input of the handwritten figure has ended.

(3) Case where the Operation Indicating that the Input of a Handwritten Figure has Ended is Performed

When the user performs the operation indicating that the input of a handwritten figure has ended, the controller 100 determines that the input of the handwritten figure has ended. For example, the controller 100 causes the display 110 to present a button such as “input end” and, when the user selects the button, determines that the input of the handwritten figure has ended.

When the input of the handwritten figure has not ended, the controller 100 returns to Step S3020 to continuously receive the input of a handwritten figure (No in Step S3040, Step S3020).

When it is determined that the input of the handwritten figure has ended, the controller 100 stores the input handwritten figure together with the content ID of the content presented on the display 110, the creator, and the information on the position as the handwritten figure information 154 (Yes in Step S3040, Step S3060).

The controller 100 sets, as the position to be stored in the handwritten figure information 154, for example, a predetermined position (any of the four corners in the case of a rectangular area) on the boundary line of the area including the handwritten figure input for the content. The controller 100 may set, as the position to be stored in the handwritten figure information 154, the center of the area including the handwritten figure, the start position of the input of the handwritten figure, or the position around the start position.

The controller 100 may make the user previously select the user to be stored as a creator before Step S3020 is executed or may identify the user based on the operating pen used when the handwritten figure is input.

After the handwritten figure information is stored, the controller 100 causes the display 110 to present a menu (Step S1020). As is the case with the first embodiment, the menu includes the item “clip image”. Items other than “clip image” may include, for example, the item for exclusively storing a handwritten figure as a comment without acquiring the image based on the content or the item for simply remaining a handwritten figure on the content without storing the handwritten figure as a comment.

Subsequently, the controller 100 executes the processes from Step S1040 to Step S1100 to specify the area of the content based on the operation input via the inputter 120.

Subsequently, the controller 100 stores, as a comment, the image of the handwritten figure of the received input at Step S3020 and the image based on the content acquired based on the area set at Step S1100 (Step S3080).

For example, the controller 100 stores, as the comment information 156, the comment in which the image based on the content acquired on the basis of the area set at Step S1100 is the first image and the image of the handwritten figure of the received input at Step S3020 is the second image. The position and the creator stored as the comment information 156 may be identical to the position and the creator stored at Step S3060. As the comment ID stored as the comment information 156, the comment ID generated by using a predetermined method may be stored.

### 6.2 Operation Example

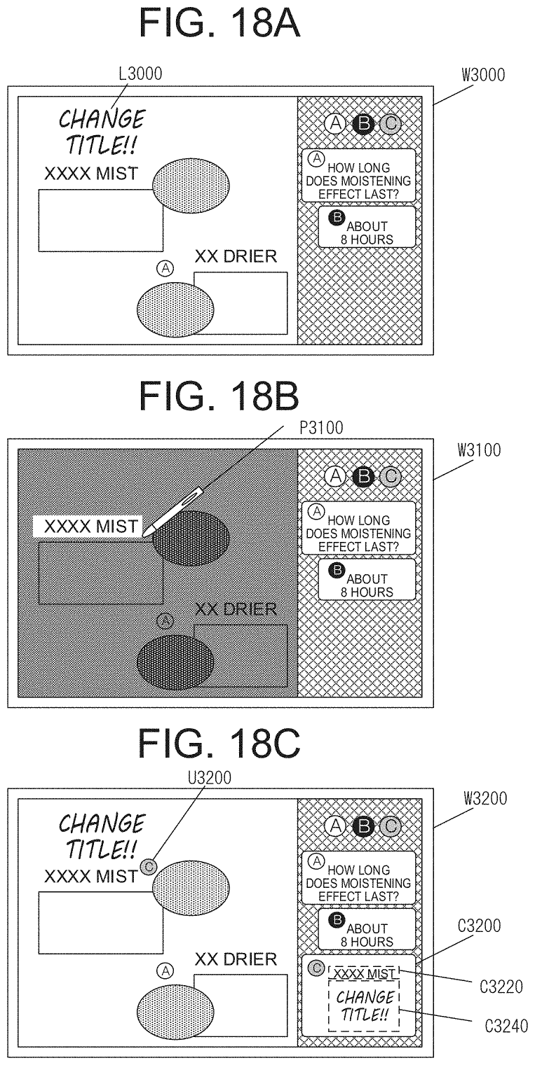

An operation example according to the present embodiment is described with reference to FIGS. 18A to 18C. FIG. 18A is a diagram illustrating a display screen W3000 presented on the display 110 when a handwritten figure is input to the content. For example, lines L3000 forming the characters are input by the user as a handwritten figure and presented on the display 110.

When the input of the handwritten figure for the content has ended and “clip image” has been selected from the menu, the display screen presented on the display 110 transitions from the display screen W3000 to a display screen W3100 illustrated in FIG. 18B. FIG. 18B illustrates a screen that is similar to the display screen W1200 illustrated in FIG. 13C according to the first embodiment and that, when a drag operation is input by the user using an operating pen P3100, brightly presents the area specified based on the drag operation.

When the area of the content is set, the display screen presented on the display 110 transitions from the display screen W3100 to a display screen W3200 illustrated in FIG. 18C. In a comment C3200 presented on the display screen W3200, a partial image C3220 of the content stored as a comment and an image C3240 of the handwritten figure input for the content are presented. The user may view the comment C3200 so as to check for which part of the content the comment of the handwritten figure has been input by the user.

A user icon U3200 is presented at the position of the lower right corner of a rectangular area E3200 including the handwritten figure. The user may view the user icon U3200 so as to identify the user (“C” in the example of FIG. 18C) who has input the handwritten figure (handwritten comment) input around the user icon U3200.

According to the present embodiment, the display device acquires a partial image of the content after receiving the input of a handwritten figure for the content and stores the image of the handwritten figure and the partial image of the content as a comment. Thus, for the user, the input of a handwritten comment and the selection of an area of the content may be efficiently performed.

### 7. Seventh Embodiment

Next, a seventh embodiment is described. The seventh embodiment is an embodiment in which the image based on the content that is the background of the comment box is automatically acquired and is stored as a comment.

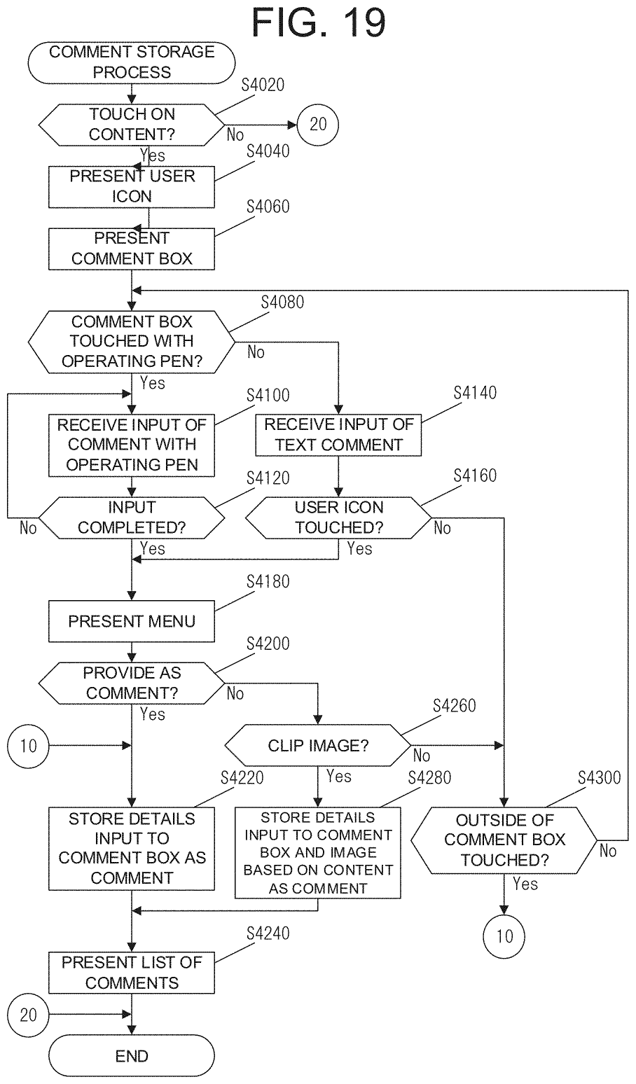

According to the present embodiment, the controller 100 executes the comment storage process illustrated in FIG. 19. The controller 100 executes the comment storage process illustrated in FIG. 19 after a user interface screen for performing the process to display content and a comment is generated by the UI processor 104 and is presented on the display 110.

First, when a touch operation is performed on the content presented on the display 110 via the inputter 120, the controller 100 causes a user icon to be presented at the position where the touch operation has been performed (Step S4020, Step S4040). At Step S4020, the controller 100 may determine that a touch operation has been performed when a single touch is detected or may determine that a touch operation has been performed when a gesture, such as long press or double tap, is detected. This allows the user to specify the location where a comment is to be added.

Subsequently, the controller 100 causes a comment box to be presented (Step S4060). For example, the controller 100 causes the comment box to be presented at a position around the user icon presented at Step S4040.

Subsequently, when the comment box has been touched with the operating pen, the controller 100 receives the input of the comment (handwritten figure) with the operating pen (Yes in Step S4080, Step S4100).

Subsequently, the controller 100 determines whether the input of the comment (handwritten figure) with the operating pen has completed (Step S4120). To determine whether the input of the comment (handwritten figure) with the operating pen has completed, the controller 100 may perform the same process as the process at Step S3040 during the comment storage process described according to the sixth embodiment.

When the input of the comment (handwritten figure) with the operating pen has not completed, the controller 100 returns to Step S4100 to continuously receive the input of a comment with the operating pen (No in Step S4120, Step S4100).

Conversely, when it is not determined at Step S4080 that the comment box has been touched with the operating pen, the controller 100 receives the input of a text comment (No in Step S4080, Step S4140). Then, the controller 100 determines whether the user icon presented at Step S4020 has been touched (Step S4160).

When the input of the comment (handwritten figure) with the operating pen has completed (Yes in Step S4120) or when the user icon presented at Step S4020 has been touched (Yes in Step S4160), the controller 100 presents the menu (Step S4180). According to the present embodiment, the menu presented at Step S4180 include the items “provide as comment” and “clip image”.

Subsequently, the controller 100 determines whether “provide as comment” has been selected from the menu presented at Step S4180 (Step S4200).

When comment providing has been selected, the details (object) input to the comment box is stored as a comment together with the content ID, the comment ID, the creator, and the information on the position (Yes in Step S4200, Step S4220). Specifically, the controller 100 stores, as the comment information 156, the details (object) input to the comment box as a comment together with the content ID, the comment ID, the creator, and the information on the position. The content ID, the comment ID, the creator, and the information on the position are the same information as the information stored at Step S1120 during the comment storage process according to the first embodiment.

Subsequently, the controller 100 (the UI processor 104) presents the list of comments (Step S4240). When “provide as comment” has been selected from the menu, the image based on the content is not stored as a comment, and therefore the comment presented at Step S4240 exclusively includes the details (object) input to the comment box.

Conversely, when “provide as comment” has not been selected at Step S4200, the controller 100 determines whether “clip image” has been selected (No in Step S4200, Step S4260).

When “clip image” has been selected (Yes in Step S4260), the controller 100 acquires an image based on the content in the area that is the background of the comment box. The controller 100 stores the details input to the content box and the image based on the content as a comment (Step S4280).

The method for acquiring the image based on the content in the area that is the background of the comment box is described. In order to acquire the image based on the content, for example, the controller 100 specifies the area where the comment box is superimposed, determines that the specified area is an area from which the image based on the content is acquired, and acquires the image based on the content in the area.

The controller 100 may use a predetermined method to expand the area from which the image based on the content is acquired. For example, the controller 100 may measure the distance between a character or an image included in the area where the comment box is superimposed and another adjacent character or image and extend the area to the position with the distance larger than a predetermined value. The character searched by the display device 10 may be the text (character) of an object, the character formed by a handwritten figure, or the text (character) included in the image based on content. The controller 100 may expand the area so as to include a group image including (a set of) images adjacent to the image included in the area.

The controller 100 may obtain the distance between an object included in the area from which the image based on the content is acquired and an object outside the area and, based on the distance, determine whether to expand the area from which the image based on the content is acquired. When it is difficult to determine whether the area is to be expanded based on only the distance between objects, the controller 100 may execute character recognition, semantic recognition, and figure recognition and expand the area, from which the image based on the content is acquired, to the range in which text makes sense.

The controller 100 expands the area from which the image based on the content is acquired by using the method described above and acquires the image based on the content in the area so as to acquire the meaningful image based on the content and obtain the meaning of the comment more clearly.

At Step S4280, the controller 100 stores, as the comment information 156, the content input to the comment box and the acquired image based on the content as a comment together with the content ID, the comment ID, the creator, and the information on the position. The content ID, the comment ID, the creator, and the information on the position are the same information as the information stored at Step S1120 during the comment storage process according to the fourth embodiment.

After the process at Step S4280 is completed, the controller 100 (the UI processor 104) presents a list of comments (Step S4240). When “clip image” has been selected from the menu, the image based on the content acquired at Step S4280 is also stored as a comment. Therefore, the comment presented at Step S4240 includes the partial image of the content and the details (object) input to the comment box.

When the user icon has not been touched at Step S4160 (No in Step S4160) or when “clip image” has not been selected from the menu at Step S4260 (No in Step S4260), the controller 100 determines whether a touch operation has been performed on the outside of the comment box (Step S4300).

When the outside of the comment box has been touched, the controller 100 executes the process at Step S4220 to store the details input to the comment box as a comment (Yes in Step S4300, Step S4220). Conversely, when the outside of the comment box has not been touched, the controller 100 returns to Step S4080 (No in Step S4300, Step S4080).

According to the present embodiment, the display device automatically acquires the image based on the content that is the background of the comment. Therefore, the user may simply select the location to which a comment is to be added and input the comment so as to provide the details of the input comment and the partial image of the content as a comment.

### 8. Eighth Embodiment

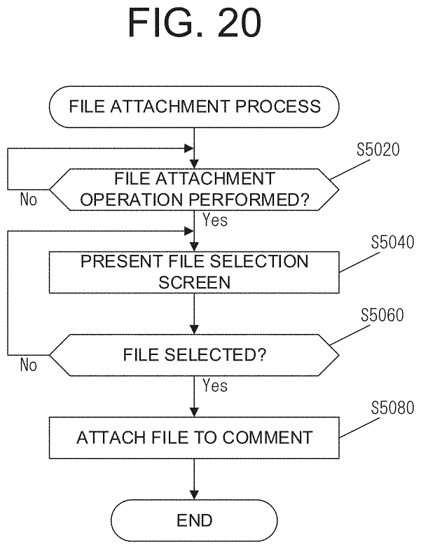

Next, an eighth embodiment is described. The eighth embodiment is an embodiment in which a file may be attached to a comment. According to the present embodiment, in addition to the processes executed according to the fourth embodiment to the eighth embodiment, the controller 100 executes a file attachment process illustrated in FIG. 20.

### 8.1 Process Flow

The file attachment process is described with reference to FIG. 20. The controller 100 executes the file attachment process illustrated in FIG. 20 when the comment storage process or the comment storage/addition process is executed. For example, the controller 100 executes the comment storage process or the comment storage/addition process in parallel to the file attachment process.

According to the present embodiment, the controller 100 (the UI processor 104) reads the comment information 156 and presents an identification presentation (e.g., user icon) on the content presented on the display 110 based on the position stored in the comment information 156. The controller 100 (the UI processor 104) presents a comment box when the user icon is selected by the user. The controller 100 (the UI processor 104) presents, in the comment box, the comment added to the location where the user icon selected by the user is presented and a clip button.

First, the controller 100 determines whether the operation has been performed to attach a file (Step S5020). The operation to attach a file is, for example, the user's operation to select the clip button presented in the comment box. The operation to attach a file may be the operation (drag and drop) to drag the file to be attached and drop the file on the comment box or the comment presented in a list.

When the operation has been performed to attach a file, the controller 100 performs control so that the display 110 presents a file selection screen for selecting the file to be attached to the comment (Yes in Step S5020, Step S5040).

The controller 100 causes the file selection screen to be presented until a file is selected by the user (No in Step S5060, Step S5040). Conversely, when a file is selected by the user, the controller 100 attaches the file selected by the user to the comment (Yes in Step S5060, Step S5080).

Specifically, the controller 100 associates the comment information 156 corresponding to the comment to which the file is to be attached with the information on the file selected by the user at Step S5060. For example, the controller 100 stores the file itself to be attached or the storage location (e.g., file path or URL) of the file in the comment information 156 corresponding to the comment to which the file is to be attached. Any method may be used as long as a comment and a file may be associated with each other, and the controller 100 may use the method of storing the comment ID of the comment to which the file is to be attached and the file selected by the user in the storage 150 in association with each other.

When the user performs the operation so as to present the file attached to the comment, the controller 100 causes the display 110 to present the file attached to the comment in accordance with the user's operation.

### 8.2 Operation Example

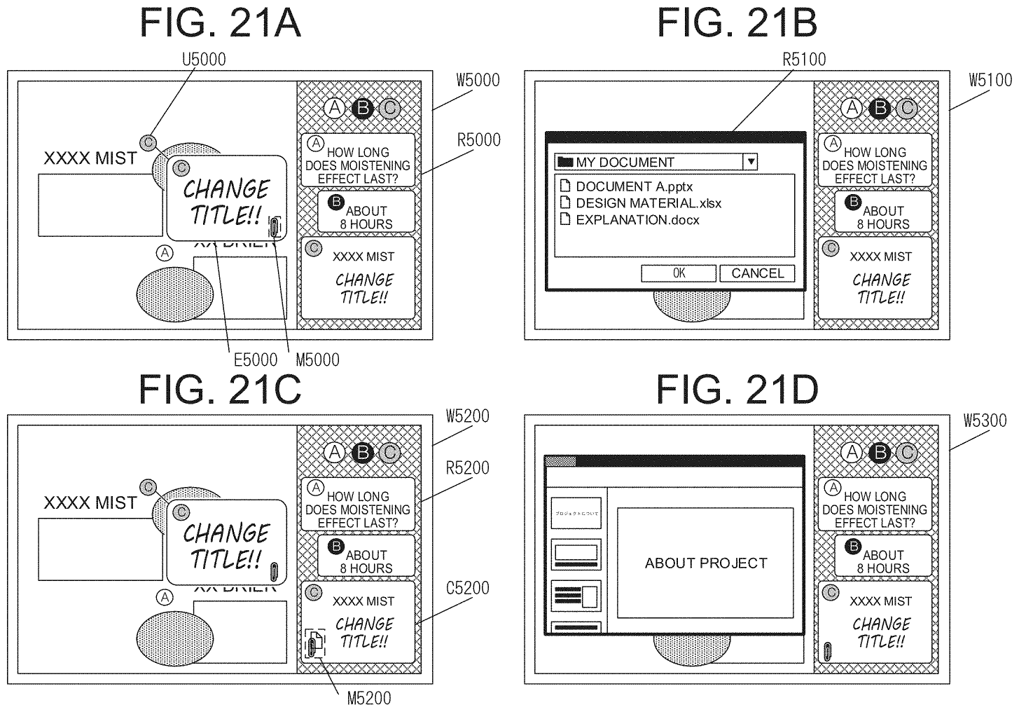

An operation example according to the present embodiment is described with reference to FIGS. 21A to 21D. FIG. 21A is a diagram illustrating an example of a display screen W5000 on which content is presented. At the right end of the display screen W5000, an area R5000 for presenting a list of comments is provided.

The display screen W5000 presents a user icon U5000. When the user selects the user icon U5000, a comment box E5000 presents the comment added to the position where the selected user icon U5000 is presented.

The comment box E5000 includes a clip button M5000. When the user performs the operation to select the clip button M5000, a display screen W5100 including a file selection screen R5100 is presented as illustrated in FIG. 21B. The user selects the file to be attached to the comment from the file selection screen R5100. Thus, the file is attached to the comment.

FIG. 21C is a diagram illustrating an example of a display screen W5200 in a case where the file to be attached to the comment is selected by the user. On an area R5200 provided at the right end of the display screen W5200 and displaying the list of comments, the comment with the file attached thereto is provided with the presentation indicating that the file is attached. For example, like a comment C5200 to which the file is attached, a clipping button M5200 is presented as the presentation indicating that the file is attached to the comment. In this case, the clipping button M5200 may be used as a button for receiving the operation to display the file attached to the comment.

When the clipping button M5200 is selected by the user, the file attached to the comment is opened by a predetermined application and a display screen W5300 presenting the details of the file is displayed, as illustrated in FIG. 21D.

According to the present embodiment, the user may attach the associated file to a comment. With regard to the attached file, the details of the file may be presented in accordance with an operation on the comment presented in a list. Thus, the user may perceive the comment added to the content and the file associated with the comment simply by viewing the list of comments.

### 9. Ninth Embodiment

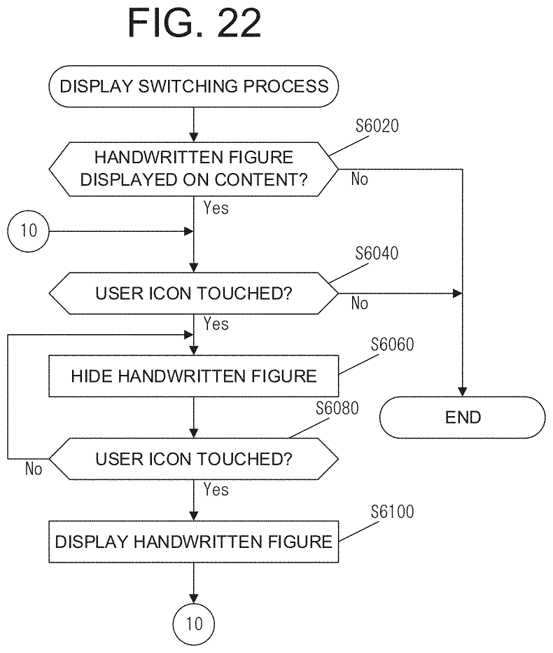

Next, a ninth embodiment is described. The ninth embodiment is an embodiment in which the controller 100 performs control to make a switch so as to display or hide a handwritten figure presented on the content in a superimposed manner. According to the present embodiment, in addition to the processes performed according to the fourth embodiment to the eighth embodiment, the controller 100 executes a display switching process illustrated in FIG. 22.

### 9.1 Process Flow

The display switching process is described with reference to FIG. 22. The controller 100 executes the display switching process illustrated in FIG. 22 when the comment storage process or the comment storage/addition process is executed. For example, the controller 100 executes the comment storage process or the comment storage/addition process in parallel to the display switching process.

According to the present embodiment, the controller 100 reads the handwritten figure information 154 and causes the handwritten figure to be displayed on the content in a superimposed manner. The controller 100 causes the identification presentation (e.g., user icon) indicating the user who has input the handwritten figure to be presented on the content displayed on the display 110 based on the position stored in the handwritten figure information 154.

First, the controller 100 determines whether the handwritten figure is displayed on the content (Step S6020). The case where no handwritten figure is presented is a case where the handwritten figure information 154 is not stored in the storage 150 (a case where no handwritten figure is input for the content). When no handwritten figure is presented, the display switching process ends (No in Step S6020).

Subsequently, when a handwritten figure is presented on the content, the controller 100 then determines whether a touch input has been made to the user icon on the content (Step S6040). When it is determined that a touch input has been made to the user icon on the content, the controller 100 hides the handwritten figure input at the position indicated by the selected user icon (Yes in Step S6040, Step S6060).

Specifically, the controller 100 refrains from reading, from the handwritten figure information 154, the handwritten figure information input at the position indicated by the user icon to which a touch input has been made. Then, the controller 100 displays the handwritten figure again to prevent the handwritten figure input at the position indicated by the selected user icon from being displayed on the content in a superimposed manner. The controller 100 keeps the user icon on the content displayed.

Subsequently, the controller 100 determines whether a touch input has been made to the user icon selected by the user at Step S6040 (Step S6080). When it is determined that a touch input has been made to the user icon, the controller 100 displays the handwritten figure input at the position indicated by the selected user icon (Yes in Step S6080, Step S6100). Specifically, the controller 100 reads, from the handwritten figure information 154, the handwritten figure input at the position indicated by the user icon to which a touch input has been made and presents the read handwritten figure on the content displayed on the display 110 in a superimposed manner.

After performing the process at Step S6100, the controller 100 may proceed to the process at Step S6040 so as to perform the process to hide the handwritten figure again.

### 9.2 Operation Example

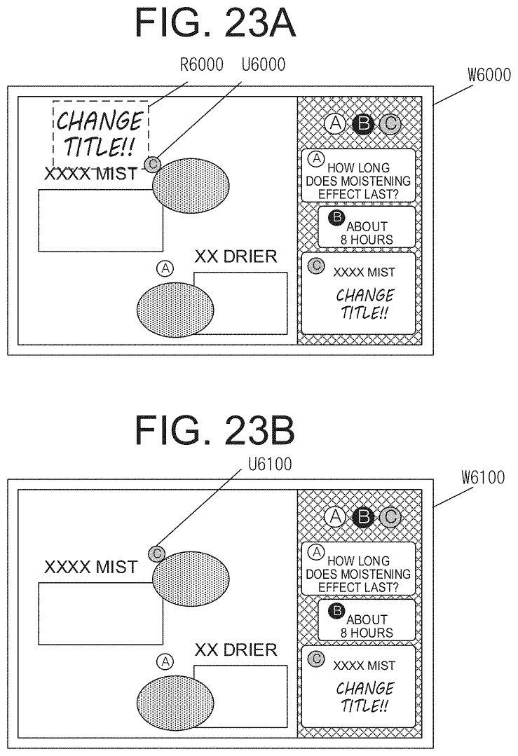

An operation example according to the present embodiment is described with reference to FIGS. 23A and 23B. FIG. 23A is a diagram illustrating an example of a display screen W6000 in which a handwritten figure is displayed on the content in a superimposed manner. An area R6000 illustrated in FIG. 23A is an area including a handwritten figure input by the user C. A user icon U6000 indicating the user C is presented as an identification presentation near the handwritten figure input by the user C.

When the touch input, which is the operation to select the user icon U6000, is detected, a display screen W6100 in which the handwritten figure input at the position indicated by the user icon U6000 is hidden is displayed, as illustrated in FIG. 23B. A user icon M6100 indicating the user C is displayed.

When the touch input, which is the operation to select the user icon U6100, is detected on the display screen W6100, the handwritten figure input at the position indicated by the user icon U6100 is displayed. As a result, the display screen like the display screen W6000 illustrated in FIG. 23A is displayed again. Thus, each time the user icon is selected, it is possible to make a switch to display or hide the handwritten figure input at the position indicated by the user icon.

According to the present embodiment, the user may perform a simple operation of selecting the identification presentation to make a switch so as to display or hide a handwritten figure that is generally difficult to hide or needs a complicated operation to hide. This allows the user to always ensure the area for inputting a handwritten figure.

In the description according to the present embodiment, displaying and hiding of a handwritten figure are switched for each area to which the handwritten figure is input; however, displaying and hiding of a handwritten figure may be switched for each user, or displaying and hiding of a handwritten figure may be collectively switched for all the comments.

### 10. Modification

The present invention is not limited to the above-described embodiments, and various modifications may be made. That is, the technical scope of the present invention also includes an embodiment obtained by combining technical measures that are appropriately modified without departing from the scope of the present invention.

Each function may be configured as a program or may be configured as hardware. When a function is implemented as a program, the program may be recorded on a recording medium and loaded from the recording medium to be executed or may be stored in a network and downloaded to be executed.

Although some parts of the above-described embodiments are described separately for convenience of explanation, it is obvious that the embodiments may be combined to be executed within a technically possible range.

For example, the fourth embodiment and the sixth embodiment may be combined. For example, the controller 100 of the display device 10 presents the menu as described in the fourth embodiment when a specific gesture such as long press is detected, and receives the input of a handwritten figure for content when an input of other than the specific gesture is detected.

The ninth embodiment and the tenth embodiment may be combined. For example, the controller 100 of the display device 10 receives the attachment of a file when a handwritten input, which is input to content, is stored as a comment and make a switch between displaying and hiding when a handwritten input is not stored as a comment.

A program that operates in each device according to the embodiment is a program that controls a CPU or the like (a program that causes a computer to function) so as to perform the function according to the above-described embodiment. The information processed by these devices is temporarily stored in a temporary storage device (e.g., a RAM) during the processing and then stored in various storage devices such as ROM, HDD, or SSD so as to be loaded, corrected, or written by the CPU as appropriate.

For distribution to the market, the program may be stored and distributed in a portable recording medium or transferred to a server computer connected via a network such as the Internet. In this case, it is obvious that the present invention also includes a storage device of the server computer.

An application having each function may be installed and executed in various devices such as a smartphone, a tablet, or an image forming apparatus so as to perform the function.

What is claimed is:

1. A display device comprising:
a display that presents content;
an inputter; and
a controller, wherein
the controller
receives input of a handwritten figure for the presented content via the inputter, and
outputs, as comment information, an image where the handwritten figure and an image of content in a range including the handwritten figure are superimposed.

2. The display device according to claim 1, wherein, when a predetermined output condition is satisfied, the controller outputs, as comment information, an image where the handwritten figure and an image of content in a range including the handwritten figure are superimposed.

3. The display device according to claim 2, wherein
the inputter is a touch panel, and
the output condition is that output of the comment information is selected from a menu, the menu being presented after a predetermined time has elapsed since a touch-up after the handwritten figure is input.

4. The display device according to claim 1, wherein the controller captures an image of an area including an outer circumference of the handwritten figure from the content to obtain the image of the content.

5. The display device according to claim 4, wherein, when the handwritten figure is an arrow, the controller further captures an image of an area indicated by the arrow from the content to obtain the image of the content.

6. The display device according to claim 1, wherein the controller stores the comment information in association with a file.

7. The display device according to claim 1, wherein the controller performs control to make a switch so as to display or hide the handwritten figure.

8. The display device according to claim 1, wherein the controller causes an identification presentation indicating a user who has input the handwritten figure to be presented near the handwritten figure.

9. The display device according to claim 8, wherein the controller performs control to make a switch so as to display or hide the handwritten figure in accordance with selection of the identification presentation.

10. A display device comprising:
a display that presents content;
an inputter;
a storage; and
a controller, wherein
the storage is capable of storing, as a comment, a character or an image in association with the content, and
the controller
specifies an area input via the inputter from content presented on the display, and
causes a first image based on content in the specified area to be stored as a comment.

11. The display device according to claim 10, wherein
the inputter is a touch panel, and
the controller specifies the area in accordance with a touch operation received via the inputter.

12. The display device according to claim 10, wherein the controller causes a second image to be further stored as information associated with the first image.

13. The display device according to claim 12, wherein
the controller
causes the display to present an input area for inputting the second image, and
uses the second image input to the input area as information associated with the first image.

14. The display device according to claim 12, wherein the controller uses an image based on a handwritten figure input to content presented on the display as the second image.

15. The display device according to claim 14, wherein the controller performs control to make a switch so as to display or hide the handwritten figure.

16. The display device according to claim 14, wherein the controller causes an identification presentation indicating a user who has input the handwritten figure to be presented near the handwritten figure.

17. The display device according to claim 16, wherein the controller performs control to make a switch so as to display or hide the handwritten figure in accordance with selection of the identification presentation.

18. The display device according to claim 10, wherein the controller causes the comment to be stored in association with a file.

19. A display device comprising:
a display that presents content;
an inputter;
a storage; and
a controller, wherein
the storage is capable of storing, as a comment, a character or an image in association with the content, and
the controller
causes the display to present an input area for inputting a first image on the content in a superimposed manner,
specifies an area including a range where the input area is superimposed, and
causes the first image input to the input area and a second image based on content in the specified area to be stored as a comment.
